(19) United States
(12) Patent Application Publication
(10) Pub. No.: US 2023/0314777 A1
(43) Pub. Date: Oct. 5, 2023

(54) PROJECTION SYSTEM AND PROJECTOR

(71) Applicant: SEIKO EPSON CORPORATION, Tokyo (JP)

(72) Inventors: Hitoshi HIRANO, Suwa-shi (JP); Nobutaka MINEFUJI, Omachi-shi (JP); Hirotaka YANAGISAWA, Azumino-shi (JP); Akihisa KAGEYAMA, Matsumoto-shi (JP)

(73) Assignee: SEIKO EPSON CORPORATION, Tokyo (JP)

(21) Appl. No.: 18/127,816

(22) Filed: Mar. 29, 2023

(30) Foreign Application Priority Data
Mar. 30, 2022 (JP) 2022-055408

(51) Int. Cl. G02B 13/16; G02B 9/06

(52) U.S. Cl. CPC G02B 13/16; G02B 9/06

(57) ABSTRACT

A projection system includes a first lens group having positive power, an aperture stop, and a second lens group having positive power sequentially arranged from the enlargement side toward the reduction side. The portion at the reduction side of a reduction-side lens that forms the second lens group and is located at a position closest to the reduction side is a telecentric portion. The projection system satisfies Conditional Expressions (1) and (2) below,

ω>40° (1)

YL1/YIM<6.0 (2)

where ω represents a maximum half angle of view of the overall projection system, YIM represents the distance from an optical axis to the largest image height of the projection image formed at an image formation device, and YL1 is the distance from the optical axis to a chief beam corresponding to the maximum image height in an imaginary plane.

The present application is based on, and claims priority from JP Application Serial Number 2022-055408, filed Mar. 30, 2022, the disclosure of which is hereby incorporated by reference herein in its entirety.

### BACKGROUND

### 1. Technical Field

The present disclosure relates to a projection system and a projector.

### 2. Related Art

JP-A-2009-104048 describes a projector that enlarges a projection image formed at an image display device and projects the enlarged projection image onto a screen via a projection system. The projection system described in JP-A-2009-104048 includes a first lens group having negative power and a second lens group having positive power sequentially arranged from the enlargement side toward the reduction side. The lens that forms the first lens group and is disposed at a position closest to the enlargement side is an aspherical lens and has the largest effective diameter among a plurality of lenses that constitute the projection system. The second lens group includes an aperture stop.

The projection system incorporated in a projector needs to be a wide-angle, compact optical system. The projection system described in JP-A-2009-104048 has a half angle of view greater than 40°, which is a wide angle of view. In the projection system described in JP-A-2009-104048, however, the lens that forms the first lens group and is disposed at a position closest to the enlargement side is greater than the largest image height of a projection image formed at the image display device. The projection system described in JP-A-2009-104048 therefore has room for improvement in size reduction in the radial direction.

### SUMMARY

To solve the problem described above, a projection system according to an aspect of the present disclosure is a projection system for enlarging a projection image formed by an image formation device disposed in a reduction-side conjugate plane and projecting the enlarged image onto an enlargement-side conjugate plane. The projection system includes a first lens group having positive power, and an aperture stop, and a second lens group having positive power sequentially arranged from an enlargement side toward a reduction side. A portion at the reduction side of a reduction-side lens that forms the second lens group and is located at a position closest to the reduction side is a telecentric portion. The projection system satisfies Conditional Expressions (1) and (2) below,

ω>40° (1)

YL1/YIM<6.0 (2)

where ω represents a maximum half angle of view of the overall projection system, YIM represents a distance from an optical axis to a largest image height of the projection image formed at the image formation device, and YL1 is a distance from the optical axis to a chief beam corresponding to the maximum image height in an imaginary plane that is perpendicular to the optical axis and passes through a vertex of an enlargement-side lens surface of an enlargement-side lens that forms the first lens group and is located at a position closest to the enlargement side.

A projector according to another aspect of the present disclosure includes the projection system described above and the image formation device that forms a projection image in the reduction-side conjugate plane of the projection system.

### BRIEF DESCRIPTION OF THE DRAWINGS

FIG. 1 shows a schematic configuration of a projector including a projection system according to an embodiment of the present disclosure.

FIG. 2 is a beam diagram showing beams passing through the projection system.

FIG. 3 is a beam diagram showing beams passing through the projection system according to Example 1.

FIG. 4 shows a longitudinal aberration, astigmatism, and distortion in Example 1.

FIG. 5 is a beam diagram showing beams passing through the projection system according to Example 2.

FIG. 6 shows the longitudinal aberration, astigmatism, and distortion in Example 2.

FIG. 7 is a beam diagram showing beams passing through the projection system according to Example 3.

FIG. 8 shows the longitudinal aberration, astigmatism, and distortion in Example 3.

FIG. 9 is a beam diagram showing beams passing through the projection system according to Example 4.

FIG. 10 shows the longitudinal aberration, astigmatism, and distortion in Example 4.

FIG. 11 is a beam diagram showing beams passing through the projection system according to Example 5.

FIG. 12 shows the longitudinal aberration, astigmatism, and distortion in Example 5.

FIG. 13 is a beam diagram showing beams passing through the projection system according to Example 6.

FIG. 14 shows the longitudinal aberration, astigmatism, and distortion in Example 6.

FIG. 15 is a beam diagram showing beams passing through the projection system according to Example 7.

FIG. 16 shows the longitudinal aberration, astigmatism, and distortion in Example 7.

### DESCRIPTION OF EXEMPLARY EMBODIMENTS

An optical system and a projector according to an embodiment of the present disclosure will be described below with reference to the drawings.

### Projector

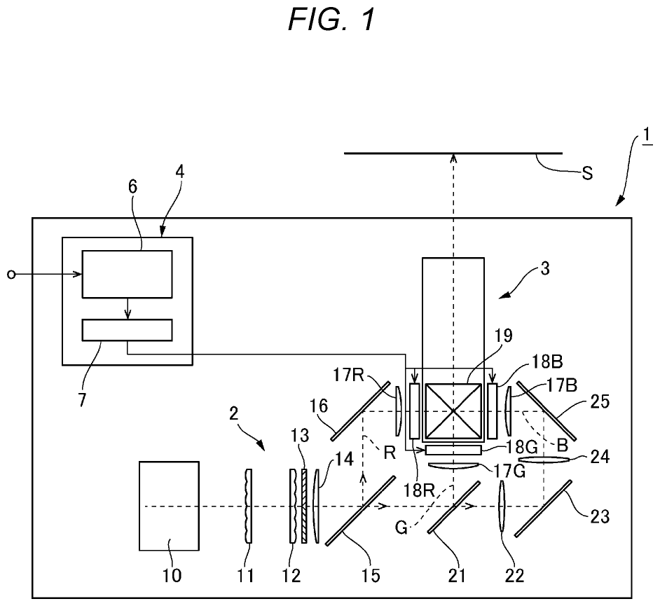

FIG. 1 shows a schematic configuration of a projector including a projection system 3 according to the embodiment of the present disclosure. A projector 1 includes an image formation unit 2, which generates a projection image to be projected onto a screen S, the projection system 3, which enlarges the projection image and projects the enlarged image onto the screen S, and a controller 4, which controls the operation of the image formation unit 2, as shown in FIG. 1.

### Image Formation Unit and Controller

The image formation unit 2 includes a light source 10, a first optical integration lens 11, a second optical integration lens 12, a polarization converter 13, and a superimposing lens 14. The light source 10 is formed, for example, of an ultrahigh-pressure mercury lamp ora solid-state light source. The first optical integration lens 11 and the second optical integration lens 12 each include a plurality of lens elements arranged in an array. The first optical integration lens 11 divides a luminous flux from the light source 10 into a plurality of luminous fluxes. The lens elements of the first optical integration lens 11 bring the luminous flux from the light source 10 into focus in the vicinity of the lens elements of the second optical integration lens 12.

The polarization converter 13 converts the light via the second optical integration lens 12 into predetermined linearly polarized light. The superimposing lens 14 superimposes images of the lens elements of the first optical integration lens 11 on one another in a display region of each of liquid crystal panels 18R, 18G, and 18B, which will be described later, via the second optical integration lens 12.

The image formation unit 2 further includes a first dichroic mirror 15, a reflection mirror 16, a field lens 17R, and the liquid crystal panel 18R. The first dichroic mirror 15 reflects R light, which is part of the beam incident via the superimposing lens 14, and transmits G light and B light, which are part of the beam incident via the superimposing lens 14. The R light reflected off the first dichroic mirror 15 travels via the reflection mirror 16 and the field lens 17R and is incident on the liquid crystal panel 18R. The liquid crystal panel 18R is an image formation device. The liquid crystal panel 18R modulates the R light in accordance with an image signal to form a red projection image.

The image formation unit 2 further includes a second dichroic mirror 21, a field lens 17G, and the liquid crystal panel 18G. The second dichroic mirror 21 reflects the G light, which is part of the beam via the first dichroic mirror 15, and transmits the B light, which is part of the beam via the first dichroic mirror 15. The G light reflected off the second dichroic mirror 21 passes through the field lens 17G and is incident on the liquid crystal panel 18G. The liquid crystal panel 18G is an image formation device. The liquid crystal panel 18G modulates the G light in accordance with an image signal to form a green projection image.

The image formation unit 2 further includes a relay lens 22, a reflection mirror 23, a relay lens 24, a reflection mirror 25, a field lens 17B, the liquid crystal panel 18B, and a cross dichroic prism 19. The B light having passed through the second dichroic mirror 21 travels via the relay lens 22, the reflection mirror 23, the relay lens 24, the reflection mirror 25, and the field lens 17B and is incident on the liquid crystal panel 18B. The liquid crystal panel 18B is an image formation device. The liquid crystal panel 18B modulates the B light in accordance with an image signal to form a blue projection image.

The liquid crystal panels 18R, 18G, and 18B surround the cross dichroic prism 19 in such away that the liquid crystal panels 18R, 18G, and 18B face three sides of the cross dichroic prism 19. The cross dichroic prism 19, which is a prism for light combination, produces a projection image that is the combination of the light modulated by the liquid crystal panel 18R, the light modulated by the liquid crystal panel 18G, and the light modulated by the liquid crystal panel 18B.

The projection system 3 enlarges the combined projection image from the cross dichroic prism 19 and projects the enlarged projection image onto the screen S.

The controller 4 includes an image processor 6, to which an external image signal, such as a video signal, is inputted, and a display driver 7, which drives the liquid crystal panels 18R, 18G, and 18B based on image signals outputted from the image processor 6.

The image processor 6 converts an image signal inputted from an external apparatus into image signals each containing grayscales and other factors of the corresponding color. The display driver 7 operates the liquid crystal panels 18R, 18G, and 18B based on the color projection image signals outputted from the image processor 6. The image processor 6 thus causes the liquid crystal panels 18R, 18G, and 18B to display projection images corresponding to the image signals.

### Projection System

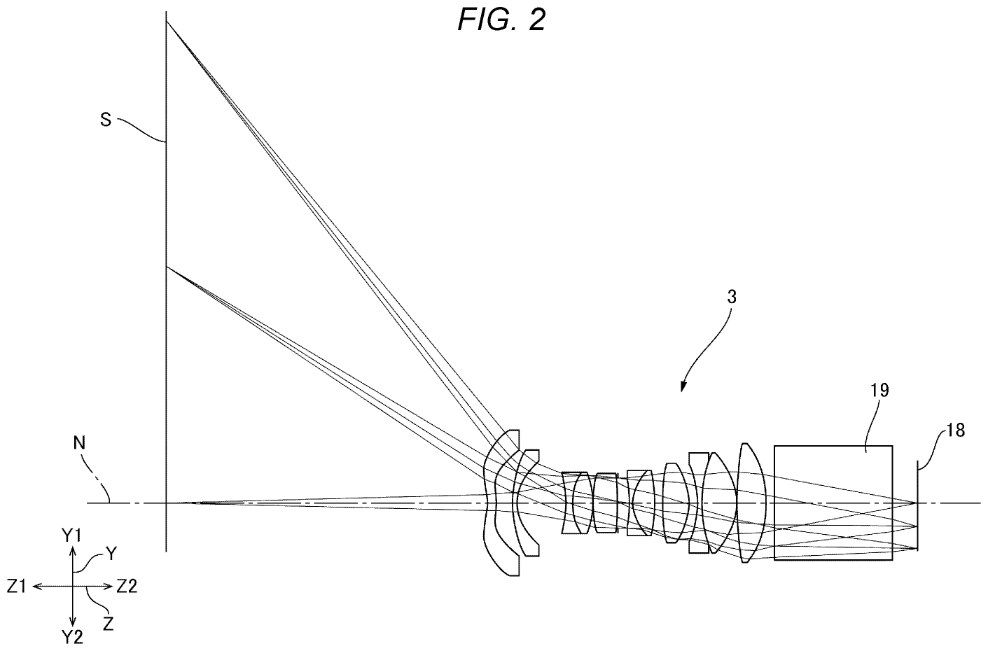

The projection system 3 will next be described. FIG. 2 is a beam diagram showing beams passing through the projection system 3. In FIG. 2, the liquid crystal panels 18R, 18G, and 18B are drawn as a liquid crystal panel 18. The screen S is disposed in the enlargement-side conjugate plane of the projection system 3, as shown in FIG. 2. The liquid crystal panel 18 is disposed in the reduction-side conjugate plane of the projection system 3.

In the following description, three axes perpendicular to one another are called axes X, Y, and Z for convenience. The direction along an optical axis N of the projection system 3 is called an axis-Z direction. The axis-Z direction toward the side where the screen S is located is called a first direction Z1, and the axis-Z direction toward the side where the liquid crystal panel 18 is located is called a second direction Z2. The axis Y extends along the screen S. The upward-downward direction is an axis-Y direction, with one side of the axis-Y direction called an upper side Y1 and the other side of the axis-Y direction called a lower side Y2. The axis X extends in the width direction of the screen.

The liquid crystal panel 18 disposed in the reduction-side conjugate plane forms a projection image at the lower side Y2 of the optical axis N of the projection system 3, as shown in FIG. 2. An enlarged image projected by the projection system 3 onto the screen S is formed at the upper side Y1 of the optical axis N.

Examples 1 to 7 will be described below as examples of the configuration of the projection system 3 incorporated in the projector 1.

### EXAMPLE 1

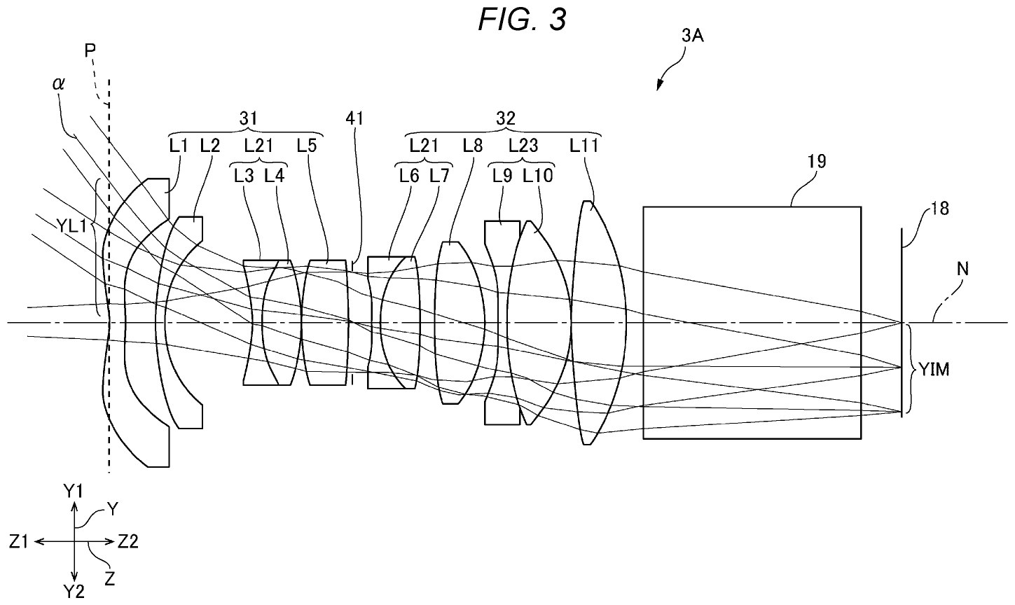

FIG. 3 is a beam diagram showing beams passing through a projection system 3A according to Example 1. The projection system 3A includes a first lens group 31 having positive power, an aperture stop 41, and a second lens group 32 having positive power sequentially arranged from the enlargement side toward the reduction side, as shown in FIG. 3. The aperture stop 41 is set to specify the brightness of the projection system 3A.

The first lens group 31 includes five lenses L1 to L5. The lenses L1 to L5 are arranged in this order from the enlargement side toward the reduction side.

The lens L1 (enlargement-side lens) has negative power. The enlargement-side surface of the lens L1 has a concave shape in the vicinity of the optical axis N and a convex shape at the periphery. The reduction-side surface of the lens L1 has a convex shape in the vicinity of the optical axis N and a concave shape at the periphery. The lens L1 has aspherical surfaces at opposite sides. The lens L2 has negative power. The lens L2 is a meniscus lens. The lens L2 has a convex surface at the enlargement side and a concave surface at the reduction side.

The lens L3 (first lens) and the lens L4 (second lens) are bonded to each other into a cemented doublet L21. The lens L3 has negative power. The lens L3 has concave surfaces both at the enlargement and reduction sides. The lens L4 has positive power. The lens L4 has convex surfaces both at the enlargement and reduction sides. The cemented doublet L21 has negative power. The lens L5 has positive power. The lens L5 has convex surfaces both at the enlargement and reduction sides.

The second lens group 32 includes six lenses L6 to L11. The lenses L6 to L11 are arranged in this order from the enlargement side toward the reduction side.

The lenses L6 and L7 are bonded to each other into a cemented doublet L22. The lens L6 has negative power. The lens L6 has concave surfaces both at the enlargement and reduction sides. The lens L7 has positive power. The lens L7 has convex surfaces both at the enlargement and reduction sides. The cemented doublet L22 has negative power.

The lens L8 has positive power. The lens L8 has convex surfaces both at the enlargement and reduction sides. The lens L8 has aspherical surfaces at opposite sides.

The lenses L9 and L10 are bonded to each other into a cemented doublet L23. The lens L9 has negative power. The lens L9 has concave surfaces both at the enlargement and reduction sides. The lens L10 has positive power. The lens L10 has convex surfaces both at the enlargement and reduction sides. The lens L10 has an aspherical surface at the reduction side. The cemented doublet L23 has positive power.

The lens L11 (reduction-side lens) has positive power. The lens L11 has convex surfaces both at the enlargement and reduction sides.

The lens L1 is made of resin. The lenses L2 to L11 are made of glass.

In the projection system 3A, the portion at the reduction side of the lens L11 is a telecentric portion. The configuration in which the portion at the reduction side of the lens L11 is a telecentric portion means that the central beam of each luminous flux traveling along the path between the lens L11 and the liquid crystal panel 18 disposed in the reduction-side conjugate plane is parallel or substantially parallel to the optical axis N.

Data on the projection system 3A according to Example 1 are listed in a table below. In the table, FNo represents the f number of the projection system 3A, TTL represents the overall optical length, L represents the distance along the optical axis N from the enlargement-side surface of the lens L1 to the reduction-side surface of the lens L11, BF represents the back focal length, ω represents the maximum half angle of view of the overall projection system, F represents the focal length of the overall projection system, Fg1 represents the focal length of the first lens group 31, Fg2 represents the focal length of the second lens group 32, Fls represents the focal length of the lens L1, Flf represents the focal length of the lens L11, and Fc represents the focal length of the cemented doublet L21.

| Fno | 2.000 | |
|---|---|---|
| TTL | 99.504 | mm |
| L | 65.000 | mm |
| BF | 34.504 | mm |
| ω | 51.161° | |
| F | 8.354 | mm |
| Fg1 | 88.353 | mm |
| Fg2 | 22.232 | mm |
| Fls | −38.968 | mm |
| Flf | 36.884 | mm |
| Fc | −99.855 | mm |

Other data on the projection system 3A according to Example 1 are listed in a table below. In the table, YIM represents the distance from the optical axis N to the largest image height of a projection image formed at the liquid crystal panel 18, and YL1 represents the distance from the optical axis N to a chief beam a corresponding to the largest image height in an imaginary plane P, which passes through the vertex of the enlargement-side lens surface of the lens L1 and is perpendicular to the optical axis N. The vertex of the lens surface is the intersection of the lens surface and the optical axis N, as shown in FIG. 3.

| | |
|---|---|
| YIM | 10.350 mm |
| YL1 | 16.536 mm |

Data on the lenses of the projection system 3A are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character vd represents the Abbe number at the d line. Reference characters R and D are expressed in millimeters.

| Reference | Surface | | | | |
|---|---|---|---|---|---|
| character | number | R | D | nd | νd |
| S | 0 | inf | 10900.000 | | |
| L01 | 1* | −8.14 | 2.000 | 1.5311 | 55.8 |
| | 2* | −14.53 | 3.787 | | |
| L02 | 3 | 27.80 | 1.206 | 1.9229 | 20.9 |
| | 4 | 12.03 | 11.013 | | |
| L03 | 5 | −19.85 | 1.200 | 1.7725 | 49.6 |
| L04 | 6 | 12.60 | 4.818 | 1.6889 | 31.1 |
| | 7 | −22.43 | 0.100 | | |
| L05 | 8 | 25.56 | 5.807 | 1.7283 | 28.5 |
| | 9 | −77.33 | 0.574 | | |
| 41 | 10 | inf | 2.483 | | |
| L06 | 11 | −36.11 | 1.000 | 1.9537 | 32.3 |
| L07 | 12 | 10.64 | 5.023 | 1.7847 | 25.7 |
| | 13 | −42.29 | 1.815 | | |
| L08 | 14* | 41.75 | 6.298 | 1.4971 | 81.6 |
| | 15* | −13.75 | 1.895 | | |
| L09 | 16 | −23.31 | 1.000 | 2.0006 | 25.5 |
| L10 | 17 | 29.95 | 7.999 | 1.4971 | 81.6 |
| | 18* | −15.31 | 0.100 | | |
| L11 | 19 | 69.43 | 6.88 | 1.4970 | 81.55 |
| | | −24.17 | 2.00 | | |
| 19 | 20 | inf | 27.43 | 1.52 | 64.20 |
| | | inf | 5.03 | | |
| 18 | 21 | inf | 0.05 | | |

The aspherical coefficients are listed below.

| Surface number | 1 | 2 |
|---|---|---|
| Conic constant | −3.55898E+00 | −3.59351E−02 |
| Third-order | 2.03084E+01 | 9.32258E+00 |
| coefficient | | |
| Fourth-order | 1.99441E+01 | 1.12957E+01 |
| coefficient | | |
| Fifth-order | −9.32560E+01 | −1.57267E+00 |
| coefficient | | |
| Sixth-order | 1.00422E+02 | −1.75079E+01 |
| coefficient | | |
| Seventh-order | −2.57668E+01 | 2.01490E+00 |
| coefficient | | |
| Eighth-order | −2.17920E+01 | 1.55978E+01 |
| coefficient | | |
| Ninth-order | 1.28981E+01 | −4.65184E−01 |
| coefficient | | |
| Tenth-order | −5.46354E−01 | −5.36687E+00 |
| coefficient | | |

| Surface number | 14 | 15 | 18 |
|---|---|---|---|
| Conic constant | 6.77949E+00 | −2.54428E−01 | −1.63386E+00 |
| Fourth-order | −1.21234E−05 | 6.23756E−05 | −4.75133E−05 |
| coefficient | | | |
| Sixth-order | −7.57407E−08 | −2.01718E−07 | |
| coefficient | | | |
| Eighth-order | −2.10980E−09 | −2.37450E−09 | |
| coefficient | | | |
| Tenth-order | 2.16919E−11 | 8.17896E−12 | |
| coefficient | | | |
| Twelfth-order | −4.85082E−14 | | |
| coefficient | | | |

The projection system 3A according to the present example satisfies Conditional Expressions (1) and (2) below,

ω>40° (1)

YL1/YIM<6.0 (2)

where ω represents the maximum half angle of view of the overall projection system, YIM represents the distance from the optical axis N to the largest image height of the projection image formed at the liquid crystal panel 18, and YL1 represents the distance from the optical axis N to a chief beam a corresponding to the largest image height in the imaginary plane P, which passes through the vertex of the enlargement-side lens surface of the lens L1 and is perpendicular to the optical axis N.

In the present example,

| | |
|---|---|
| ω | 51.161° |
| YIM | 10.350 mm |
| YL1 | 16.536 mm |

are satisfied. Therefore, ω=51.161° is provided, so that Conditional Expression (1) is satisfied. YL1/YIM=1.598 is achieved, so that Conditional Expression (2) is satisfied.

The projection system 3A according to the present example satisfies all Conditional Expressions (3), (4), and (5) below,

BF/F>2.0 (3)

−15.0<Fls/F<−1.8 (4)

1.6<Flf/F<15.0 (5)

where F represents the focal length of the overall projection system, BF represents the back focal length in air, Fls represents the focal length of the lens L1, and Flf represents the focal length of the lens L11.

In the present example,

| | |
|---|---|
| Bf | 34.504 mm |
| F | 8.354 mm |
| Fls | −38.968 mm |
| Flf | 36.884 mm |

are satisfied. BF/F=4.131 is therefore achieved, so that Conditional Expression (3) is satisfied. Fls/F=−4.665 is achieved, so that Conditional Expression (4) is satisfied. Flf/F=4.415 is achieved, so that Conditional Expression (5) is satisfied.

The projection system 3A according to the present example satisfies all Conditional Expressions (6), (7), and (8) below,

|Δνd|<20.0 (6)

|Δnd|<0.35 (7)

2.0<Fc/F<15.0 (8)

where F represents the focal length of the overall projection system, Δνd represents the difference in Abbe number at the d line between the lenses L3 and L4, Δnd represents the difference in refractive index at the d line between the lenses L3 and L4, and Fc represents the focal length of the cemented doublet L21.

In the present example,

| F | 8.354 mm |
|---|---|
| Fc | −99.855 mm |
| \|Δνd\| | 18.520 |
| \|Δnd\| | 0.084 |

are satisfied. Therefore, |Δνd|=18.520 is provided, so that Conditional Expression (6) is satisfied. |Δνd|=0.084 is provided, so that Conditional Expression (7) is satisfied. Fc/F=11.954 is achieved, so that Conditional Expression (8) is satisfied.

### Effects and Advantages

The projection system 3A according to the present example, which satisfies Conditional Expression (1), is a wide-angle projection system. In the projection system 3A according to the present example, in which the first lens group 31 has positive power and which satisfies Conditional Expression (2), the lens that forms the first lens group and is disposed at a position closest to the enlargement side can be smaller than the largest image height of the proj ection image formed at the liquid crystal panel 18.

That is, when the first lens group 31 has positive power, the lens that forms the first lens group and is disposed at a position closest to the enlargement side is readily smaller than the largest image height of the projection image formed at the liquid crystal panel 18 as compared with the case where the first lens group 31 has negative power. When the value of Conditional Expression (2) is greater than the upper limit, the first lens group 31 has negative power. Therefore, when the value of Conditional Expression (2) is greater than the upper limit, the lens that forms the first lens group and is disposed at a position closest to the enlargement side is greater than the largest image height of the projection image formed by the liquid crystal panel 18, so that the radial dimension of the projection system 3A increases.

Example 2 described in JP-A-2009-104048, which is a literature of related art, will now be examined as Comparable Example. The projection system according to Comparable Example includes a first lens group and a second lens group sequentially arranged from the enlargement side toward the reduction side. The second lens group includes an aperture stop. In the projection system according to Comparative Example, the lens group disposed at the enlargement side of the aperture stop has positive power. The lens group disposed at the reduction side of the aperture stop has positive power. Data on the projection system according to Comparable Example are listed below.

| | |
|---|---|
| Ω | 59.60° |
| YIM | 1.756 mm |
| YL1 | 12.394 mm |

In Comparable Example, ω=59.6°. The projection system according to Comparable Example therefore satisfies Conditional Expression (1). In Comparative Example, however, the value YL1/YIM of Conditional Expression (2) is 7.059. Therefore, in the projection system according to Comparative Example, the lens group disposed at the enlargement side of the aperture stop has positive power but does not satisfy Conditional Expression (2). Therefore, when the maximum half angle of view is fixed and the lens group disposed at the enlargement side of the aperture stop has positive power, YL1/YIM in Comparative Example is greater than YL1/YIM of the projection system 3A according to the present example. That is, in the projection system according to Comparative Example, as compared with the projection system 3A according to the present example, the lens that forms the first lens group and is disposed at a position closest to the enlargement side is greater than the maximum image height of the projection image formed at the image display device.

In the present example, the lens L1 has negative power. The maximum half angle of view of the projection system 3A is therefore readily increased. In the present example, the lens L11 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1 and L2 are negative lenses disposed in succession from a position closest to the enlargement side toward the reduction side. The lens L1 is an aspherical lens made of plastic. According to the configuration described above, image curvature produced by the projection system 3A can be suppressed.

The projection system 3A according to the present example satisfies all Conditional Expressions (3), (4), and (5) below,

BF/F>2.0 (3)

−15.0<Fls/F<−1.8 (4)

1.6<Flf/F<15.0 (5)

where F represents the focal length of the overall projection system, BF represents the back focal length in air, Fls represents the focal length of the lens L1, and Flf represents the focal length of the lens L11.

The projection system 3A, which satisfies Conditional Expression (3), readily ensures a sufficient back focal length. That is, when the value of Conditional Expression (3) is smaller than the lower limit, the back focal length is too short, and it is therefore difficult to provide a space for a light combining prism, compensators for the liquid crystal panels, and other components disposed at the reduction side of the second lens group 32. It is further difficult for the portion at the reduction side of the second lens group 32 to serve as a telecentric portion.

Furthermore, the projection system 3A according to the present example, which satisfies Conditional Expression (4), can ensure the image formation performance of the projection system 3A while ensuring a sufficient back focal length. That is, when the value of Conditional Expression (4) is smaller than the lower limit, the focal length Fls of the lens L1 is too short. The image formation performance of the projection system 3A can thus be ensured, but the power of the lens L1 increases, and it is therefore difficult to provide a sufficiently long back focal length. When the value of Conditional Expression (4) is greater than the upper limit, the focal length Fls of the lens L1 is too long. The power of the lens L1 thus decreases, so that the image formation performance of the projection system 3A deteriorates while a sufficiently long back focal length is provided.

Furthermore, the projection system 3A according to the present example, which satisfies Conditional Expression (5), can ensure the image formation performance thereof with the portion at the reduction side of the second lens group 32 serving as a telecentric portion. That is, when the value of Conditional Expression (5) is smaller than the lower limit, the focal length Flf of the lens L11 is too short. The image formation performance of the projection system 3A can thus be ensured, but the power of the lens L11 increases, and it is difficult for the reduction side of the second lens group 32 to serve as a telecentric portion. When the value of Conditional Expression (5) is greater than the upper limit, the focal length Flf of the lens L11 is too long. The power of the lens L11 thus decreases, so that the image formation performance of the projection system 3A deteriorates while the reduction side of the second lens group 32 readily serves as a telecentric portion.

The first lens group 31 includes the cemented doublet L21, into which the lens L3 (first lens) and the second lens L4 (second lens) are bonded to each other. The projection system 3A satisfies all Conditional Expressions (6), (7), and (8) below,

|Δνd|<20.0 (6)

|Δnd|<0.35 (7)

2.0<Fc/F<15.0 (8)

where F represents the focal length of the overall projection system, Δνd represents the difference in Abbe number at the d line between the lenses L3 and L4, Δnd represents the difference in refractive index at the d line between the lenses L3 and L4, and Fc represents the focal length of the cemented doublet L21.

The projection system 3A, which satisfies Conditional Expressions (6) and (7), can satisfactorily correct the chromatic aberration of magnification. That is, when the values of Conditional Expressions (6) and (7) are greater than the upper limits, it is difficult to satisfactorily correct the chromatic aberration of magnification.

The projection system 3A, which satisfies Conditional Expression (8), can have a short overall length while satisfactorily correcting the chromatic aberration of magnification. That is, when the value of Conditional Expression (8) is smaller than the lower limit, the focal length Fc of the cemented doublet L21 is too short. The power of the cemented doublet L21 thus increases, so that the chromatic aberration of magnification can be satisfactorily corrected, and the overall length of the projection system 3A can be shortened, but a variety of aberrations are likely to be produced. When the value of Conditional Expression (8) is greater than the upper limit, the focal length Fc of the cemented doublet L21 is too long. The power of the cemented doublet L21 therefore decreases, so that the production of the aberrations is suppressed, but the chromatic aberration of magnification cannot be satisfactorily corrected, and the overall length of the projection system 3A increases.

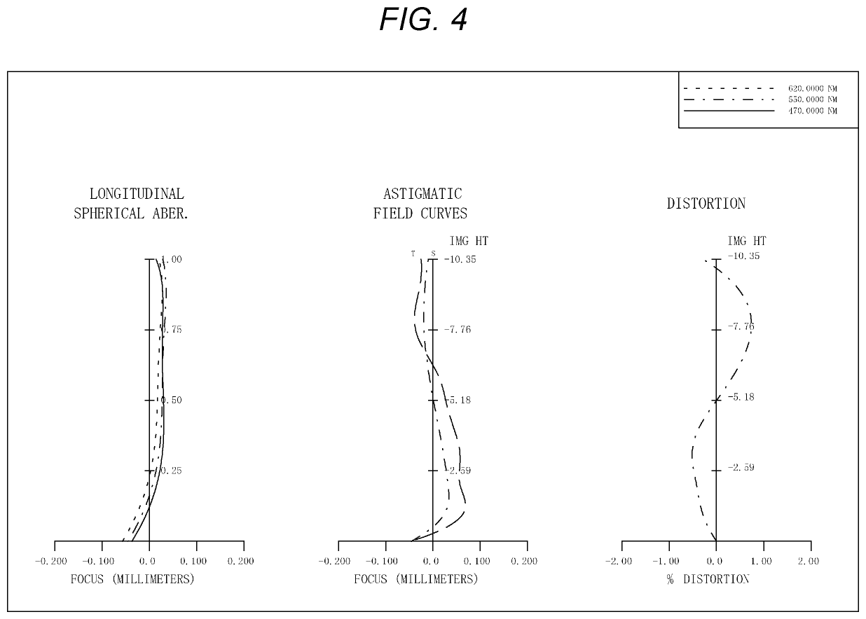

FIG. 4 shows the spherical aberration, astigmatism, and distortion produced by the projection system 3A. The projection system 3A according to the present example allows suppression of the aberrations that degrade an enlarged image, as shown in FIG. 4.

### EXAMPLE 2

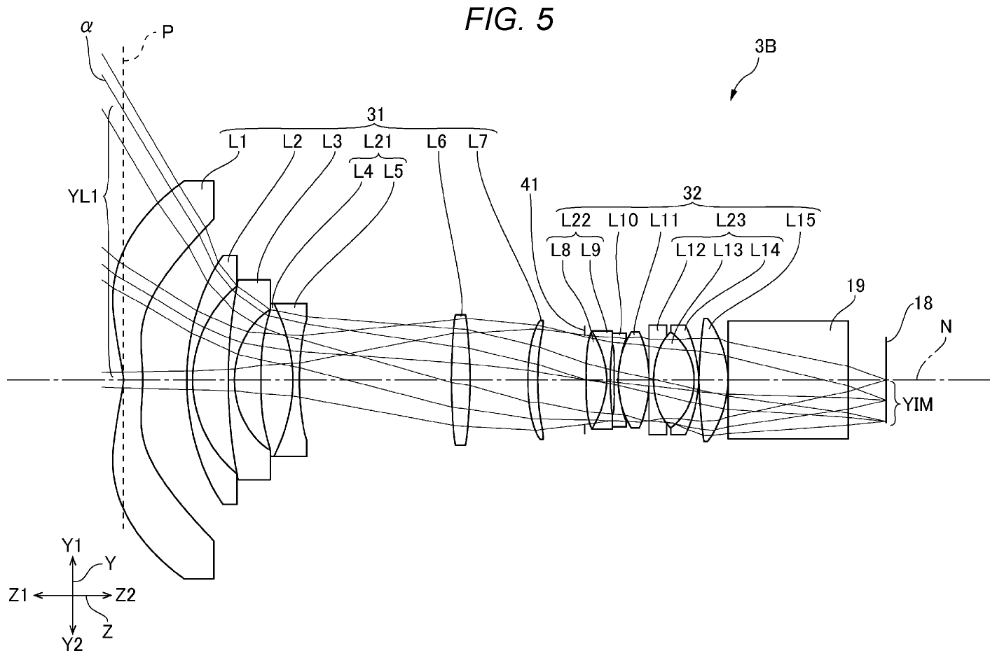

FIG. 5 is a beam diagram showing beams passing through a projection system 3B according to Example 2. The projection system 3B includes a first lens group 31 having positive power, an aperture stop 41, and a second lens group 32 having positive power sequentially arranged from the enlargement side toward the reduction side, as shown in FIG. 5. The aperture stop 41 is set to specify the brightness of the projection system 3B.

The first lens group 31 includes seven lenses L1 to L7. The lenses L1 to L7 are arranged in this order from the enlargement side toward the reduction side.

The lens L1 (enlargement-side lens) has negative power. The enlargement-side surface of the lens L1 has a concave shape in the vicinity of the optical axis N and a convex shape at the periphery. The reduction-side surface of the lens L1 has a convex shape in the vicinity of the optical axis N and a concave shape at the periphery. The lens L1 has aspherical surfaces at opposite sides.

The lens L2 has negative power. The lens L2 is a meniscus lens. The lens L2 has a convex surface at the enlargement side and a concave surface at the reduction side. The lens L3 has negative power. The lens L3 is a meniscus lens. The lens L3 has a convex surface at the enlargement side and a concave surface at the reduction side.

The lens L4 (first lens) and the lens L5 (second lens) are bonded to each other into a cemented doublet L21. The lens L4 has positive power. The lens L4 has convex surfaces both at the enlargement and reduction sides. The lens L5 has negative power. The lens L5 has concave surfaces both at the enlargement and reduction sides. The cemented doublet L21 has negative power.

The lens L6 has positive power. The lens L6 has convex surfaces both at the enlargement and reduction sides. The lens L7 has positive power. The lens L7 is a meniscus lens. The lens L7 has a convex surface at the enlargement side and a concave surface at the reduction side.

The second lens group 32 includes eight lenses L8 to L15. The lenses L8 to L15 are arranged in this order from the enlargement side toward the reduction side.

The lenses L8 and L9 are bonded to each other into a cemented doublet L22. The lens L8 has positive power. The lens L8 has convex surfaces both at the enlargement and reduction sides. The lens L9 has negative power. The lens L9 has concave surfaces both at the enlargement and reduction sides. The cemented doublet L22 has negative power.

The lens L10 has negative power. The lens L10 has concave surfaces both at the enlargement and reduction sides. The lens L11 has positive power. The lens L11 has convex surfaces both at the enlargement and reduction sides. The lens L11 has aspherical surfaces at opposite sides.

The lenses L12, L13, and L14 are bonded to each other into a cemented triplet L23. The lens L12 has negative power. The lens L12 has concave surfaces both at the enlargement and reduction sides. The lens L13 has positive power. The lens L13 has convex surfaces both at the enlargement and reduction sides. The lens L14 has negative power. The lens L14 is a meniscus lens. The lens L14 has a concave surface at the enlargement side and a convex surface at the reduction side. The cemented triplet L23 has negative power.

The lens L15 (reduction-side lens) has positive power. The lens L15 has convex surfaces both at the enlargement and reduction sides.

The lens L1 is made of resin. The lenses L2 to L15 are made of glass.

In the projection system 3B, the portion at the reduction side of the lens L15 is a telecentric portion.

Data on the projection system 3B according to Example 2 are listed in a table below. In the table, FNo represents the f number of the projection system 3B, TTL represents the overall optical length, L represents the distance along the optical axis N from the enlargement-side surface of the lens L1 to the reduction-side surface of the lens L15, BF represents the back focal length, ω represents the maximum half angle of view of the overall projection system, F represents the focal length of the overall projection system, Fg1 represents the focal length of the first lens group 31, Fg2 represents the focal length of the second lens group 32, Fls represents the focal length of the lens L1, Flf represents the focal length of the lens L15, and Fc represents the focal length of the cemented doublet L21.

| Fno | 1.600 | |
|---|---|---|
| TTL | 196.072 | mm |
| L | 155.632 | mm |
| Bf | 40.440 | mm |
| ω | 59.527° | |
| F | 6.346 | mm |
| Fg1 | 19.516 | mm |
| Fg2 | 40.014 | mm |
| Fls | −82.470 | mm |
| Flf | 40.479 | mm |
| Fc | −70.861 | mm |

Other data on the projection system 3B according to Example 2 are listed in a table below. In the table, YIM represents the distance from the optical axis N to the largest image height of a projection image formed at the liquid crystal panel 18, and YL1 represents the distance from the optical axis N to a principal beam a at the maximum image height in an imaginary plane P, which passes through the vertex of the enlargement-side lens surface of the lens L1 and is perpendicular to the optical axis N, as shown in FIG. 5.

| | |
|---|---|
| YIM | 10.800 mm |
| YL1 | 48.804 mm |

Data on the lenses of the projection system 3B are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character vd represents the Abbe number at the d line. Reference characters R and D are expressed in millimeters.

| Reference | Surface | | | | |
|---|---|---|---|---|---|
| character | number | R | D | nd | νd |
| S | 0 | inf | 937.000 | | |
| L01 | 1* | −21.05 | 5.000 | 1.5350 | 55.7 |
| | 2* | −43.44 | 11.444 | | |
| L02 | 3 | 59.15 | 1.500 | 1.6385 | 55.4 |
| | 4 | 31.36 | 9.264 | | |
| L03 | 5 | 134.83 | 1.500 | 1.6584 | 50.9 |
| | 6 | 22.52 | 6.868 | | |
| L04 | 7 | 71.57 | 8.262 | 1.5814 | 40.7 |
| L05 | 8 | −39.51 | 1.500 | 1.9037 | 31.3 |
| | 9 | 60.49 | 39.168 | | |
| L06 | 10 | 116.63 | 4.721 | 1.7283 | 28.5 |
| | 11 | −143.94 | 14.752 | | |
| L07 | 12 | 36.13 | 2.703 | 1.8467 | 23.8 |
| | 13 | 72.81 | 12.287 | | |
| 41 | 14 | inf | 0.100 | | |
| L08 | 15 | 57.80 | 5.329 | 1.7283 | 28.5 |
| L09 | 16 | −21.22 | 1.000 | 1.8515 | 40.8 |
| | 17 | 106.42 | 0.911 | | |
| L10 | 18 | −366.07 | 1.000 | 1.8515 | 40.8 |
| | 19 | 26.00 | 0.20 | | |
| L11 | 20* | 22.18 | 7.83 | 1.5866 | 59.0 |
| | 21* | −31.15 | 0.15 | | |
| L12 | 22 | −315.90 | 1.00 | 1.8467 | 23.8 |
| L13 | 23 | 19.79 | 10.50 | 1.4970 | 81.5 |
| L14 | 24 | −15.29 | 1.00 | 1.7620 | 40.1 |
| | 25 | −30.98 | 0.15 | | |
| L15 | 26 | 84.76 | 7.50 | 1.4970 | 81.5 |
| | 27 | −25.69 | 0.10 | | |
| 19 | 28 | inf | 30.69 | 1.5168 | 64.2 |
| 18 | 29 | inf | 9.62 | | |

The aspherical coefficients are listed below.

| Surface number | 1 | 2 |
|---|---|---|
| Conic constant | −4.65698E+00 | 0.00000E+00 |
| Third-order | 6.40812E−04 | 5.97213E−04 |
| coefficient | | |
| Fourth-order | −6.67159E−06 | 3.19711E−05 |
| coefficient | | |
| Fifth-order | −1.19688E−07 | −1.04449E−06 |
| coefficient | | |
| Sixth-order | 3.18694E−10 | −1.02162E−09 |
| coefficient | | |
| Seventh-order | 2.14148E−11 | 1.04227E−10 |
| coefficient | | |
| Eighth-order | 1.32953E−12 | 2.50920E−12 |
| coefficient | | |
| Ninth-order | −2.74043E−15 | 5.10421E−14 |
| coefficient | | |
| Tenth-order | −1.99411E−16 | 5.14582E−16 |
| coefficient | | |
| Eleventh-order | −9.09455E−18 | −1.34495E−17 |
| coefficient | | |
| Twelfth-order | −1.15855E−19 | −5.34850E−19 |
| coefficient | | |
| Thirteenth-order | 2.95122E−21 | −1.35806E−20 |
| coefficient | | |
| Fourteenth-order | 7.72821E−23 | −2.14658E−22 |
| coefficient | | |
| Fifteenth-order | 3.24485E−25 | −8.84318E−25 |
| coefficient | | |
| Sixteenth-order | −8.46992E−27 | 8.78914E−26 |
| coefficient | | |
| Seventeenth-order | −2.38266E−28 | 4.39353E−27 |
| coefficient | | |
| Eighteenth-order | −4.92232E−30 | 1.02850E−28 |
| coefficient | | |
| Nineteenth-order | −1.60652E−32 | 6.22593E−31 |
| coefficient | | |
| Twentieth-order | 1.90227E−33 | −6.48263E−32 |
| coefficient | | |
| Surface number | 20 | 21 |
| Conic constant | −8.64572E−01 | −1.36585E+00 |
| Fifth-order | −1.00607E−05 | −4.36799E−06 |
| coefficient | | |
| Sixth-order | 1.43627E−08 | −2.18442E−08 |
| coefficient | | |
| Eighth-order | −4.94939E−11 | −5.00791E−11 |
| coefficient | | |
| Tenth-order | 2.97500E−14 | −5.34787E−14 |
| coefficient | | |

The projection system 3B according to the present example satisfies Conditional Expressions (1) and (2) below,

ω>40° (1)

YL1/YIM<6.0 (2)

where ω represents the maximum half angle of view of the overall projection system, YIM represents the distance from the optical axis N to the largest image height of the projection image formed at the liquid crystal panel 18, and YL1 represents the distance from the optical axis N to a chief beam a corresponding to the largest image height in an imaginary plane P, which passes through the vertex of the enlargement-side lens surface of the lens L1 and is perpendicular to the optical axis N.

In the present example,

| | |
|---|---|
| ω | 59.527° |
| YIM | 10.800 mm |
| YL1 | 48.804 mm |

are satisfied. Therefore, ω=59.527° is provided, so that Conditional Expression (1) is satisfied. YL1/YIM=4.519 is achieved, so that Conditional Expression (2) is satisfied.

The projection system 3B according to the present example satisfies all Conditional Expressions (3), (4), and (5) below,

BF/F>2.0 (3)

−15.0<Fls/F<−1.8 (4)

1.6<Flf/F<15.0 (5)

where F represents the focal length of the overall projection system, BF represents the back focal length in air, Fls represents the focal length of the lens L1, and Flf represents the focal length of the lens L15.

In the present example,

| | |
|---|---|
| Bf | 40.440 mm |
| F | 6.346 mm |
| Fls | −82.470 mm |
| Flf | 40.479 mm |

are satisfied. BF/F=6.373 is therefore achieved, so that Conditional Expression (3) is satisfied. Fls/F=−12.996 is achieved, so that Conditional Expression (4) is satisfied. Flf/F=6.379 is achieved, so that Conditional Expression (5) is satisfied.

The projection system 3B according to the present example satisfies all Conditional Expressions (6), (7), and (8) below,

|Δνd|<20.0 (6)

|Δnd|<0.35 (7)

2.0<Fc/F<15.0 (8)

where F represents the focal length of the overall projection system, Δνd represents the difference in Abbe number at the d line between the lenses L4 and L5, Δnd represents the difference in refractive index at the d line between the lenses L4 and L5, and Fc represents the focal length of the cemented doublet L21.

In the present example,

| F | 6.346 mm |
|---|---|
| Fc | −70.861 mm |
| \|Δνd\| | 9.064 |
| \|Δnd\| | 0.322 |

are satisfied. Therefore, |Δνd|=9.064 is provided, so that Conditional Expression (6) is satisfied. |Δνd|=0.322 is provided, so that Conditional Expression (7) is satisfied. Fc/F=11.166 is achieved, so that Conditional Expression (8) is satisfied.

### Effects and Advantages

The projection system 3B according to the present example, which satisfies Conditional Expression (1), is a wide-angle projection system. In the projection system 3B according to the present example, in which the first lens group 31 has positive power and which satisfies Conditional Expression (2), the lens that forms the first lens group and is disposed at a position closest to the enlargement side can be smaller than the largest image height of the proj ection image formed at the liquid crystal panel 18.

In the projection system. 3B according to the present example, the lens L1 has negative power. The maximum half angle of view of the projection system 3B is therefore readily increased. In the present example, the lens L15 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1, L2, and L3 are each a negative lens having negative power. The lens L1 is an aspherical lens made of plastic. According to the configuration described above, image curvature produced by the projection system 3B can be suppressed.

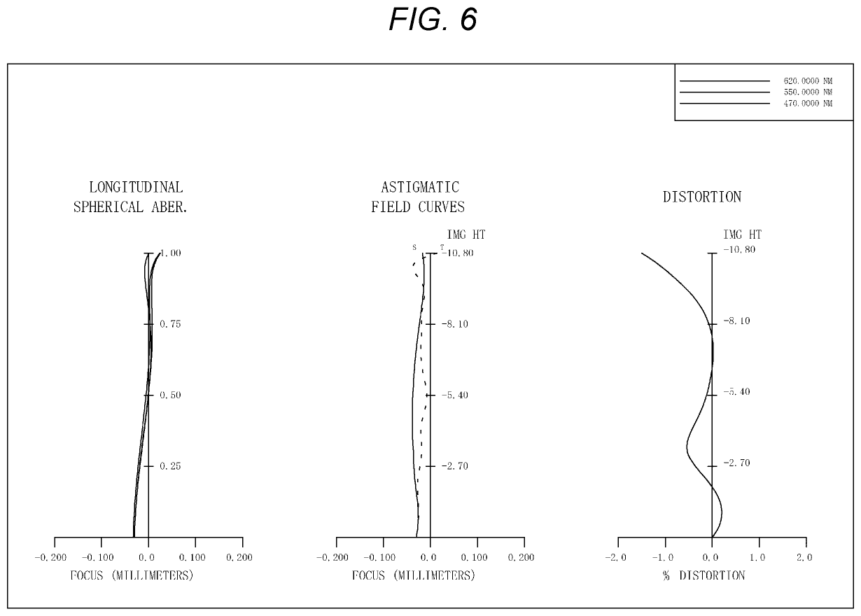

The projection system 3B according to the present example, which satisfies Conditional Expressions (3) to (8), can provide the same effects and advantages as those provided by the projection system 3A according to Example 1. FIG. 6 shows the spherical aberration, astigmatism, and distortion produced by the projection system 3B. The projection system 3B according to the present example allows suppression of the aberrations that degrade an enlarged image, as shown in FIG. 6.

### EXAMPLE 3

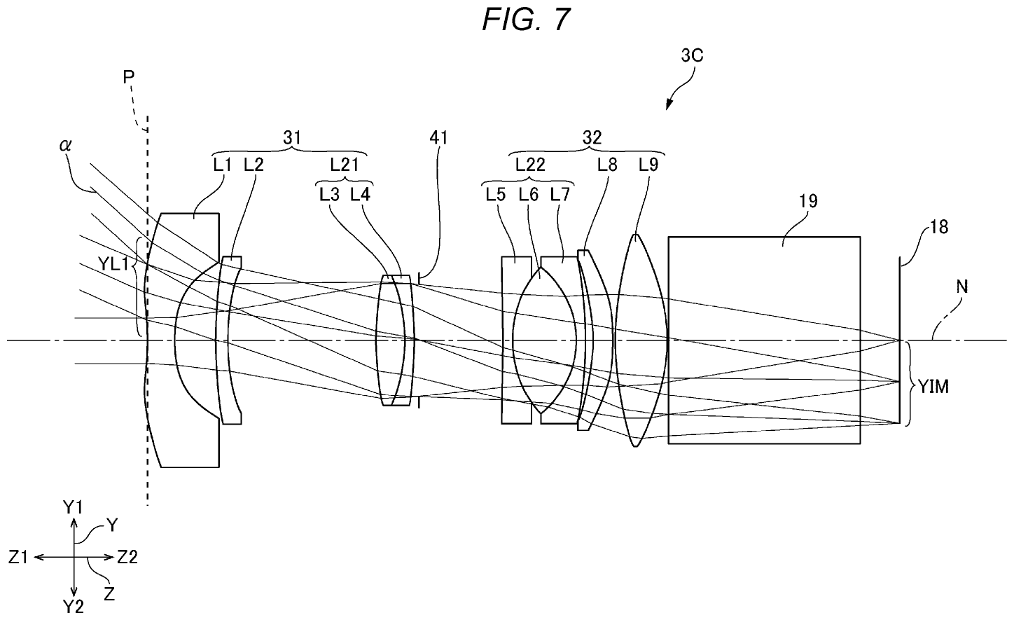

FIG. 7 is a beam diagram showing beams passing through a projection system 3C according to Example 3. The projection system 3C includes a first lens group 31 having positive power, an aperture stop 41, and a second lens group 32 having positive power sequentially arranged from the enlargement side toward the reduction side, as shown in FIG. 7. The aperture stop 41 is set to specify the brightness of the projection system 3C.

The first lens group 31 includes four lenses L1 to L4. The lenses L1 to L4 are arranged in this order from the enlargement side toward the reduction side.

The lens L1 (enlargement-side lens) has negative power. The enlargement-side surface of the lens L1 has a concave shape in the vicinity of the optical axis N and a convex shape at the periphery. The reduction-side surface of the lens L1 has a convex shape in the vicinity of the optical axis N and a concave shape at the periphery. The lens L1 has aspherical surfaces at opposite sides.

The lens L2 has negative power. The lens L2 is a meniscus lens. The lens L2 has a convex surface at the enlargement side and a concave surface at the reduction side.

The lens L3 (first lens) and the lens L4 (second lens) are bonded to each other into a cemented doublet L21. The lens L3 has positive power. The lens L3 has convex surfaces both at the enlargement and reduction sides. The lens L4 has negative power. The lens L4 is a meniscus lens. The lens L4 has a concave surface at the enlargement side and a convex surface at the reduction side. The cemented doublet L21 has negative power.

The second lens group 32 includes five lenses L5 to L9. The lenses L5 to L9 are arranged in this order from the enlargement side toward the reduction side.

The lenses L5, L6, and L7 are bonded to each other into a cemented triplet L22. The lens L5 has negative power. The lens L5 has concave surfaces both at the enlargement and reduction sides. The lens L6 has positive power. The lens L6 has convex surfaces both at the enlargement and reduction sides. The lens L7 has negative power. The lens L7 is a meniscus lens. The lens L7 has a concave surface at the enlargement side and a convex surface at the reduction side. The cemented doublet L22 has negative power.

The lens L8 has positive power. The lens L8 is a meniscus lens. The lens L8 has a concave surface at the enlargement side and a convex surface at the reduction side. The lens L9 (reduction-side lens) has positive power. The lens L9 has convex surfaces both at the enlargement and reduction sides. The lens L9 has aspherical surfaces at opposite sides.

The lens L1 is made of resin. The lenses L2 to L9 are made of glass.

In the projection system 3C, the portion at the reduction side of the lens L9 is a telecentric portion.

Data on the projection system 3C according to Example 3 are listed in a table below. In the table, FNo represents the f number of the projection system 3C, TTL represents the overall optical length, L represents the distance along the optical axis N from the enlargement-side surface of the lens L1 to the reduction-side surface of the lens L9, BF represents the back focal length, ω represents the maximum half angle of view of the overall projection system, F represents the focal length of the overall projection system, Fg1 represents the focal length of the first lens group 31, Fg2 represents the focal length of the second lens group 32, Fls represents the focal length of the lens L1, Flf represents the focal length of the lens L9, and Fc represents the focal length of the cemented doublet L21.

| Fno | 2.022 | |
|---|---|---|
| TTL | 94.125 | mm |
| L | 65.000 | mm |
| Bf | 29.125 | mm |
| ω | 41.836° | |
| F | 11.713 | mm |
| Fg1 | 28.353 | mm |
| Fg2 | 29.175 | mm |
| Fls | −22.805 | mm |
| Flf | 26.457 | mm |
| Fc | 26.205 | mm |

Other data on the projection system 3C according to Example 3 are listed in a table below. In the table, YIM represents the distance from the optical axis N to the largest image height of a projection image formed at the liquid crystal panel 18, and YL1 represents the distance from the optical axis N to a chief beam a corresponding to the largest image height in an imaginary plane P, which passes through the vertex of the enlargement-side lens surface of the lens L1 and is perpendicular to the optical axis N, as shown in FIG. 7.

| | |
|---|---|
| YIM | 10.350 mm |
| YL1 | 13.024 mm |

Data on the lenses of the projection system 3C are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character vd represents the Abbe number at the d line. Reference characters R and D are expressed in millimeters.

| Reference | Surface | | | | |
|---|---|---|---|---|---|
| character | number | R | D | nd | νd |
| S | 0 | inf | 1129.752 | | |
| L01 | 1* | −23.48 | 3.474 | 1.5365 | 56.0 |
| | 2* | 27.08 | 5.041 | | |
| L02 | 3 | 60.03 | 1.500 | 1.4970 | 81.5 |
| | 4 | 26.39 | 18.526 | | |
| L03 | 5 | 38.17 | 3.631 | 1.8502 | 30.0 |
| L04 | 6 | −20.87 | 1.200 | 1.7783 | 23.9 |
| | 7 | −59.09 | 0.628 | | |
| 41 | 8 | inf | 10.467 | | |
| L05 | 9 | −185.71 | 1.185 | 1.5955 | 39.2 |
| L06 | 10 | 14.01 | 8.000 | 1.4970 | 81.5 |
| L07 | 11 | −11.98 | 1.200 | 1.7552 | 27.5 |
| | 12 | −49.12 | 0.861 | | |
| L08 | 13 | −29.14 | 2.577 | 1.4875 | 70.2 |
| | 14 | −22.91 | 0.200 | | |
| L09 | 15* | 34.03 | 6.510 | 1.5365 | 56.0 |
| | 16* | −22.87 | 0.200 | | |
| 19 | 17 | inf | 23.925 | 1.5168 | 64.2 |
| | 18 | inf | 4.951 | | |
| 18 | 19 | inf | 0.05 | | |

The aspherical coefficients are listed below.

| Surface number | 1 | 2 |
|---|---|---|
| Conic constant | 9.79982E−01 | −1.00000E+02 |
| Third-order | −5.26163E−04 | −3.33856E−04 |
| coefficient | | |
| Fourth-order | 9.73141E−04 | 1.74274E−03 |
| coefficient | | |
| Fifth-order | −1.06181E−04 | −2.57210E−04 |
| coefficient | | |
| Sixth-order | 3.09797E−06 | 1.64780E−05 |
| coefficient | | |
| Seventh-order | 1.56807E−07 | 2.82510E−07 |
| coefficient | | |
| Eighth-order | −3.81796E−09 | −7.66840E−08 |
| coefficient | | |
| Ninth-order | −4.94478E−10 | −2.18789E−09 |
| coefficient | | |
| Tenth-order | −6.57052E−12 | 2.69128E−10 |
| coefficient | | |
| Eleventh-order | 5.48905E−13 | 2.52517E−11 |
| coefficient | | |
| Twelfth-order | 6.83865E−14 | 1.78375E−12 |
| coefficient | | |
| Thirteenth-order | 4.15052E−15 | −1.65247E−13 |
| coefficient | | |
| Fourteenth-order | −1.51501E−16 | −2.80152E−14 |
| coefficient | | |
| Fifteenth-order | −1.32438E−17 | −1.93588E−16 |
| coefficient | | |
| Sixteenth-order | −5.23600E−19 | 5.40380E−17 |
| coefficient | | |
| Seventeenth-order | 9.21135E−21 | 2.46012E−17 |
| coefficient | | |
| Eighteenth-order | −1.67077E−21 | −5.92818E−19 |
| coefficient | | |
| Nineteenth-order | 4.59226E−22 | −1.47137E−19 |
| coefficient | | |
| Twentieth-order | −1.47004E−23 | 6.79063E−21 |
| coefficient | | |

| Surface number | 15 | 16 |
|---|---|---|
| Conic constant | 0.00000E+00 | 0.00000E+00 |
| Fourth-order | −1.86424E−05 | 2.10628E−05 |
| coefficient | | |
| Sixth-order | 6.41789E−08 | 2.06661E−08 |
| coefficient | | |
| Eighth-order | −2.23860E−10 | −7.02491E−11 |
| coefficient | | |
| Tenth-order | 8.33454E−14 | −2.23189E−13 |
| coefficient | | |

The projection system 3C accoraing to tne present example satisfies Conditional Expressions (1) and (2) below,

ω>40° (1)

YL1/YIM<6.0 (2)

where ω represents the maximum half angle of view of the overall projection system, YIM represents the distance from the optical axis N to the largest image height of the projection image formed at the liquid crystal panel 18, and YL1 represents the distance from the optical axis N to a chief beam a corresponding to the largest image height in an imaginary plane P, which passes through the vertex of the enlargement-side lens surface of the lens L1 and is perpendicular to the optical axis N.

In the present example,

| | |
|---|---|
| ω | 41.836° |
| YIM | 10.350 mm |
| YL1 | 13.024 mm |

are satisfied. Therefore, ω=41.836° is provided, so that Conditional Expression (1) is satisfied. YL1/YIM=1.258 is achieved, so that Conditional Expression (2) is satisfied.

The projection system 3C according to the present example satisfies all Conditional Expressions (3), (4), and (5) below,

BF/F>2.0 (3)

−15.0<Fls/F<−1.8 (4)

1.6<Flf/F<15.0 (5)

where F represents the focal length of the overall projection system, BF represents the back focal length in air, Fls represents the focal length of the lens L1, and Flf represents the focal length of the lens L9.

In the present example,

| | |
|---|---|
| Bf | 29.125 mm |
| F | 11.713 mm |
| Fls | −22.805 mm |
| Flf | 26.457 mm |

are satisfied. BF/F=2.487 is therefore achieved, so that Conditional Expression (3) is satisfied. Fls/F=−1.947 is achieved, so that Conditional Expression (4) is satisfied. Flf/F=2.259 is achieved, so that Conditional Expression (5) is satisfied.

The projection system 3C according to the present example satisfies all Conditional Expressions (6), (7), and (8) below,

|Δνd|<20.0 (6)

|Δnd|<0.35 (7)

2.0<Fc/F<15.0 (8)

where F represents the focal length of the overall projection system, Δνd represents the difference in Abbe number at the d line between the lenses L3 and L4, Δnd represents the difference in refractive index at the d line between the lenses L3 and L4, and Fc represents the focal length of the cemented doublet L21.

In the present example,

| F | 11.713 mm |
|---|---|
| Fc | 26.205 mm |
| \|Δνd\| | 6.135 |
| \|Δnd\| | 0.072 |

are satisfied. Therefore, |Δνd|=6.135 is provided, so that Conditional Expression (6) is satisfied. |Δνd|=0.072 is provided, so that Conditional Expression (7) is satisfied. Fc/F=2.237 is achieved, so that Conditional Expression (8) is satisfied.

### Effects and Advantages

The projection system 3C according to the present example, which satisfies Conditional Expression (1), is a wide-angle projection system. In the projection system 3C according to the present example, in which the first lens group 31 has positive power and which satisfies Conditional Expression (2), the lens that forms the first lens group and is disposed at a position closest to the enlargement side can be smaller than the largest image height of the proj ection image formed at the liquid crystal panel 18.

In the projection system 3C according to the present example, the lens L1 has negative power. The maximum half angle of view of the projection system 3C is therefore readily increased. In the present example, the lens L9 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1 and L2 are each a negative lens having negative power. The lens L1 is an aspherical lens made of plastic. According to the configuration described above, image curvature produced by the projection system 3C can be suppressed.

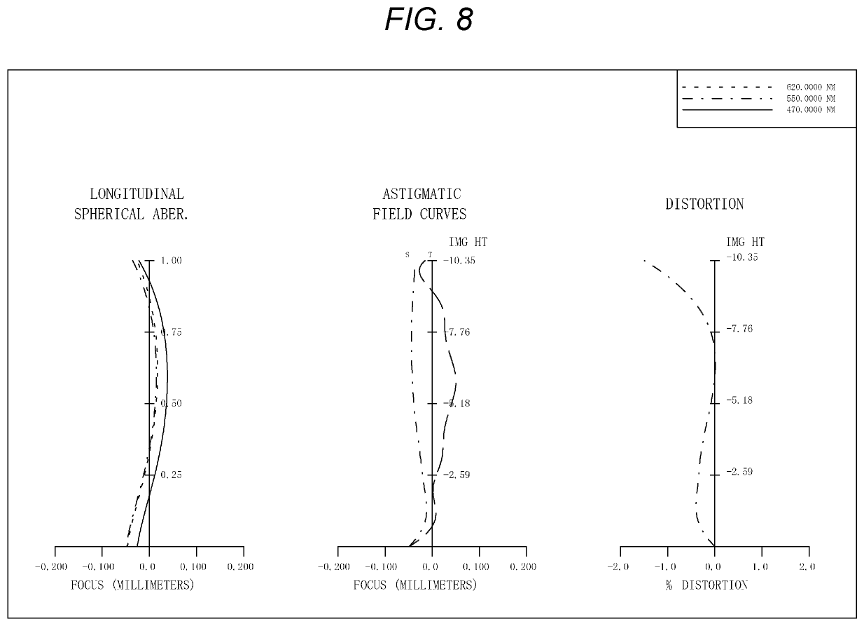

The projection system 3C according to the present example, which satisfies Conditional Expressions (3) to (8), can provide the same effects and advantages as those provided by the projection system 3A according to Example 1. FIG. 8 shows the spherical aberration, astigmatism, and distortion produced by the projection system 3C. The projection system 3C according to the present example allows suppression of the aberrations that degrade an enlarged image, as shown in FIG. 8.

### EXAMPLE 4

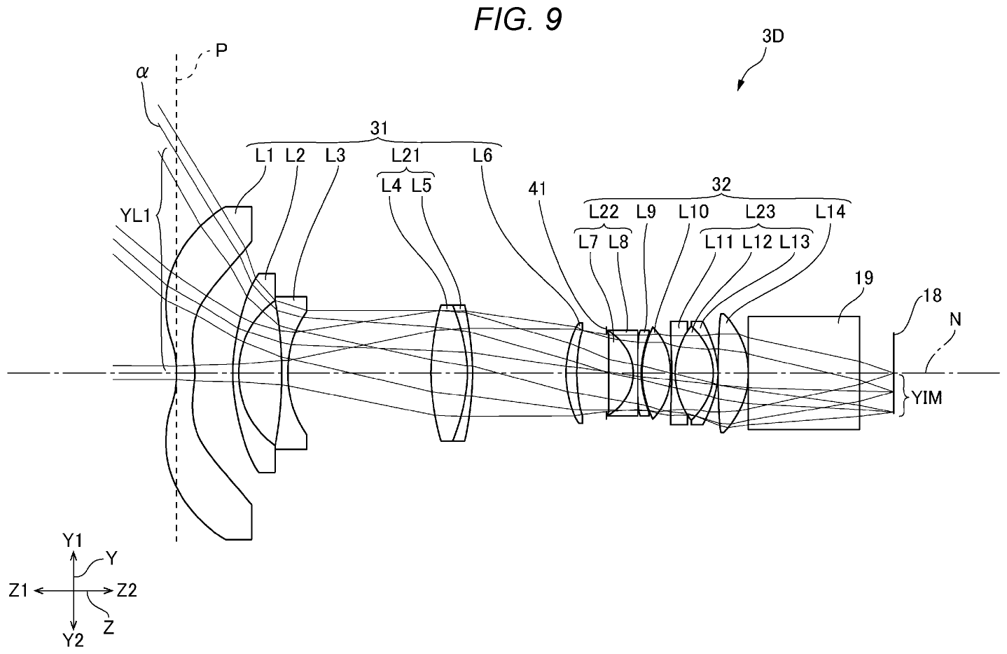

FIG. 9 is a beam diagram showing beams passing through a projection system 3D according to Example 4. The projection system 3D includes a first lens group 31 having positive power, an aperture stop 41, and a second lens group 32 having positive power sequentially arranged from the enlargement side toward the reduction side, as shown in FIG. 9. The aperture stop 41 is set to specify the brightness of the projection system 3D.

The first lens group 31 includes six lenses L1 to L6. The lenses L1 to L6 are arranged in this order from the enlargement side toward the reduction side.

The lens L1 (enlargement-side lens) has negative power. The enlargement-side surface of the lens L1 has a concave shape in the vicinity of the optical axis N and a convex shape at the periphery. The reduction-side surface of the lens L1 has a convex shape in the vicinity of the optical axis N and a concave shape at the periphery. The lens L1 has aspherical surfaces at opposite sides.

The lens L2 has negative power. The lens L2 is a meniscus lens. The lens L2 has a convex surface at the enlargement side and a concave surface at the reduction side. The lens L3 has negative power. The lens L3 has concave surfaces both at the enlargement and reduction sides.

The lens L4 (first lens) and the lens L5 (second lens) are bonded to each other into a cemented doublet L21. The lens L4 has positive power. The lens L4 has convex surfaces both at the enlargement and reduction sides. The lens L5 has negative power. The lens L5 is a meniscus lens. The lens L5 has a concave surface at the enlargement side and a convex surface at the reduction side. The cemented doublet L21 has positive power.

The lens L6 has positive power. The lens L6 is a meniscus lens. The lens L6 has a convex surface at the enlargement side and a concave surface at the reduction side.

The second lens group 32 includes eight lenses L7 to L14. The lenses L7 to L14 are arranged in this order from the enlargement side toward the reduction side.

The lenses L7 and L8 are bonded to each other into a cemented doublet L22. The lens L7 has positive power. The lens L7 is a meniscus lens. The lens L7 has a concave surface at the enlargement side and a convex surface at the reduction side. The lens L8 has negative power. The lens L8 has concave surfaces both at the enlargement and reduction sides. The cemented doublet L22 has negative power.

The lens L9 has negative power. The lens L9 is a meniscus lens. The lens L9 has a convex surface at the enlargement side and a concave surface at the reduction side. The lens L9 has aspherical surfaces at opposite sides. The lens L10 has positive power. The lens L10 has convex surfaces both at the enlargement and reduction sides.

The lenses L11, L12, and L13 are bonded to each other into a cemented triplet L23. The lens L11 has negative power. The lens L11 has concave surfaces both at the enlargement and reduction sides. The lens L12 has positive power. The lens L12 has convex surfaces both at the enlargement and reduction sides. The lens L13 has negative power. The lens L13 is a meniscus lens. The lens L13 has a concave surface at the enlargement side and a convex surface at the reduction side. The cemented triplet L23 has negative power.

The lens L14 (reduction-side lens) has positive power. The lens L14 has convex surfaces both at the enlargement and reduction sides.

The lens L1 is made of resin. The lenses L2 to L14 are made of glass.

In the projection system 3D, the portion at the reduction side of the lens L14 is a telecentric portion.

Data on the projection system 3D according to Example 4 are listed in a table below. In the table, FNo represents the f number of the projection system 3D, TTL represents the overall optical length, L represents the distance along the optical axis N from the enlargement-side surface of the lens L1 to the reduction-side surface of the lens L14, BF represents the back focal length, ω represents the maximum half angle of view of the overall projection system, F represents the focal length of the overall projection system, Fg1 represents the focal length of the first lens group 31, Fg2 represents the focal length of the second lens group 32, Fls represents the focal length of the lens L1, Flf represents the focal length of the lens L14, and Fc represents the focal length of the cemented doublet L21.

| Fno | 1.600 | |
|---|---|---|
| TTL | 198.183 | mm |
| L | 157.743 | mm |
| Bf | 40.440 | mm |
| ω | 59.589° | |
| F | 6.346 | mm |
| Fg1 | 15.031 | mm |
| Fg2 | 36.370 | mm |
| Fls | −69.014 | mm |
| Flf | 39.839 | mm |
| Fc | 60.902 | mm |

Other data on the projection system 3D according to Example 4 are listed in a table below. In the table, YIM represents the distance from the optical axis N to the largest image height of a projection image formed at the liquid crystal panel 18, and YL1 represents the distance from the optical axis N to a chief beam a corresponding to the largest image height in an imaginary plane P, which passes through the vertex of the enlargement-side lens surface of the lens L1 and is perpendicular to the optical axis N, as shown in FIG. 9.

| | |
|---|---|
| YIM | 10.800 mm |
| YL1 | 61.092 mm |

Data on the lenses of the projection system 3D are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character vd represents the Abbe number at the d line. Reference characters R and D are expressed in millimeters.

| Reference | Surface | | | | |
|---|---|---|---|---|---|
| character | number | R | D | nd | νd |
| S | 0 | inf | 937.000 | | |
| L01 | 1* | −17.94 | 4.979 | 1.5350 | 55.7 |
| | 2* | −38.13 | 10.666 | | |
| L02 | 3 | 55.43 | 1.500 | 1.8061 | 40.9 |
| | 4 | 24.82 | 12.005 | | |
| L03 | 5 | −101.52 | 1.500 | 1.8061 | 40.9 |
| | 6 | 29.05 | 39.622 | | |
| L04 | 7 | 61.72 | 9.861 | 1.6727 | 32.1 |
| L05 | 8 | −45.29 | 1.500 | 1.8467 | 23.8 |
| | 9 | −87.20 | 25.866 | | |
| L06 | 10 | 27.75 | 2.998 | 1.7618 | 26.5 |
| | 11 | 45.18 | 8.405 | | |
| 41 | 12 | inf | 0.600 | | |
| L07 | 13 | −304.47 | 6.608 | 1.7283 | 28.5 |
| L08 | 14 | −13.83 | 1.000 | 1.8515 | 40.8 |
| | 15 | 168.56 | 0.199 | | |
| L09 | 16* | 80.13 | 1.000 | 1.8344 | 37.3 |
| | 17* | 27.70 | 0.201 | | |
| L10 | 18 | 28.11 | 7.971 | 1.4875 | 70.2 |
| | 19 | −18.78 | 0.15 | | |
| L11 | 20 | −345.52 | 1.00 | 1.9037 | 31.3 |
| L12 | 21 | 21.42 | 10.50 | 1.4970 | 81.5 |
| L13 | 22 | −16.40 | 1.00 | 1.9037 | 31.3 |
| | 23 | −28.09 | 0.15 | | |
| L14 | 24 | 132.40 | 8.46 | 1.4970 | 81.5 |
| | 25 | −22.86 | 0.10 | | |
| 19 | 26 | inf | 30.69 | 1.5168 | 64.2 |
| | 27 | inf | 9.66 | | |
| 19 | 28 | inf | −0.01 | | |

The aspherical coefficients are listed below.

| Surface number | 1 | 2 |
|---|---|---|
| Conic constant | −3.98766E+00 | 0.00000E+00 |
| Third-order | 7.54720E−04 | 7.17021E−04 |
| coefficient | | |
| Fourth-order | −7.67436E−06 | 3.40907E−05 |
| coefficient | | |
| Fifth-order | −2.02752E−07 | −8.65413E−07 |
| coefficient | | |
| Sixth-order | 2.75924E−09 | −4.51327E−09 |
| coefficient | | |
| Seventh-order | 4.79235E−11 | 1.15162E−11 |
| coefficient | | |
| Eighth-order | −4.56502E−14 | 1.47502E−12 |
| coefficient | | |
| Ninth-order | −9.65806E−15 | 5.93761E−14 |
| coefficient | | |
| Tenth-order | 3.96955E−16 | 1.11149E−15 |
| coefficient | | |
| Eleventh-order | −1.25544E−17 | 6.03964E−18 |
| coefficient | | |
| Twelfth-order | −1.54368E−19 | −2.47768E−19 |
| coefficient | | |
| Thirteenth-order | 3.20580E−21 | −1.14956E−20 |
| coefficient | | |
| Fourteenth-order | 8.37917E−23 | −2.96220E−22 |
| coefficient | | |
| Fifteenth-order | 2.11755E−25 | −4.68797E−24 |
| coefficient | | |
| Sixteenth-order | −8.97852E−27 | −2.98671E−26 |
| coefficient | | |
| Seventeenth-order | −2.63525E−28 | 2.46500E−27 |
| coefficient | | |
| Eighteenth-order | −4.43567E−30 | 7.71252E−29 |
| coefficient | | |
| Nineteenth-order | −9.92722E−33 | 1.92916E−30 |
| coefficient | | |
| Twentieth-order | 2.28460E−33 | 6.41410E−32 |
| coefficient | | |

| Surface number | 16 | 17 |
|---|---|---|
| Conic constant | 0.00000E+00 | 0.00000E+00 |
| Fourth-order | −4.50613E−05 | −1.91158E−05 |
| coefficient | | |
| Sixth-order | 3.46887E−08 | 6.17285E−08 |
| coefficient | | |
| Eighth-order | 1.04484E−09 | 7.87953E−10 |
| coefficient | | |
| Tenth-order | −1.13350E−12 | −2.20160E−12 |
| coefficient | | |

The projection system 3D according to the present example satisfies Conditional Expressions (1) and (2) below,

ω>40° (1)

YL1/YIM<6.0 (2)

where ω represents the maximum half angle of view of the overall projection system, YIM represents the distance from the optical axis N to the largest image height of the projection image formed at the liquid crystal panel 18, and YL1 represents the distance from the optical axis N to a chief beam a corresponding to the largest image height in an imaginary plane P, which passes through the vertex of the enlargement-side lens surface of the lens L1 and is perpendicular to the optical axis N.

In the present example,

| | |
|---|---|
| ω | 59.589° |
| YIM | 10.800 mm |
| YL1 | 61.092 mm |

are satisfied. Therefore, ω=59.589° is provided, so that Conditional Expression (1) is satisfied. YL1/YIM=5.657 is achieved, so that Conditional Expression (2) is satisfied.

The projection system 3D according to the present example satisfies all Conditional Expressions (3), (4), and (5) below,

BF/F>2.0 (3)

−15.0<Fls/F<−1.8 (4)

1.6<Flf/F<15.0 (5)

where F represents the focal length of the overall projection system, BF represents the back focal length in air, Fls represents the focal length of the lens L1, and Flf represents the focal length of the lens L14.

In the present example,

| | |
|---|---|
| Bf | 40.440 mm |
| F | 6.346 mm |
| Fls | −69.014 mm |
| Flf | 39.839 mm |

are satisfied. BF/F=6.373 is therefore achieved, so that Conditional Expression (3) is satisfied. Fls/F=−10.875 is achieved, so that Conditional Expression (4) is satisfied. Flf/F=6.278 is achieved, so that Conditional Expression (5) is satisfied.

The projection system 3D according to the present example satisfies all Conditional Expressions (6), (7), and (8) below,

|Δνd|<20.0 (6)

|Δnd|<0.35 (7)

2.0<Fc/F<15.0 (8)

where F represents the focal length of the overall projection system, Δνd represents the difference in Abbe number at the d line between the lenses L4 and L5, Δnd represents the difference in refractive index at the d line between the lenses L4 and L5, and Fc represents the focal length of the cemented doublet L21.

In the present example,

| F | 6.346 mm |
|---|---|
| Fc | 60.902 mm |
| \|Δνd\| | 8.321 |
| \|Δnd\| | 0.174 |

are satisfied. Therefore, |Δνd|=8.321 is provided, so that Conditional Expression (6) is satisfied. |Δνd|=0.174 is provided, so that Conditional Expression (7) is satisfied. Fc/F=9.597 is achieved, so that Conditional Expression (8) is satisfied.

### Effects and Advantages

The projection system 3D according to the present example, which satisfies Conditional Expression (1), is a wide-angle projection system. In the projection system 3D according to the present example, in which the first lens group 31 has positive power and which satisfies Conditional Expression (2), the lens that forms the first lens group and is disposed at a position closest to the enlargement side can be smaller than the largest image height of the proj ection image formed at the liquid crystal panel 18.

In the projection system 3D according to the present example, the lens L1 has negative power. The maximum half angle of view of the projection system 3D is therefore readily increased. In the present example, the lens L14 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1, L2, and L3 are each a negative lens having negative power. The lens L1 is an aspherical lens made of plastic. According to the configuration described above, image curvature produced by the projection system 3D can be suppressed.

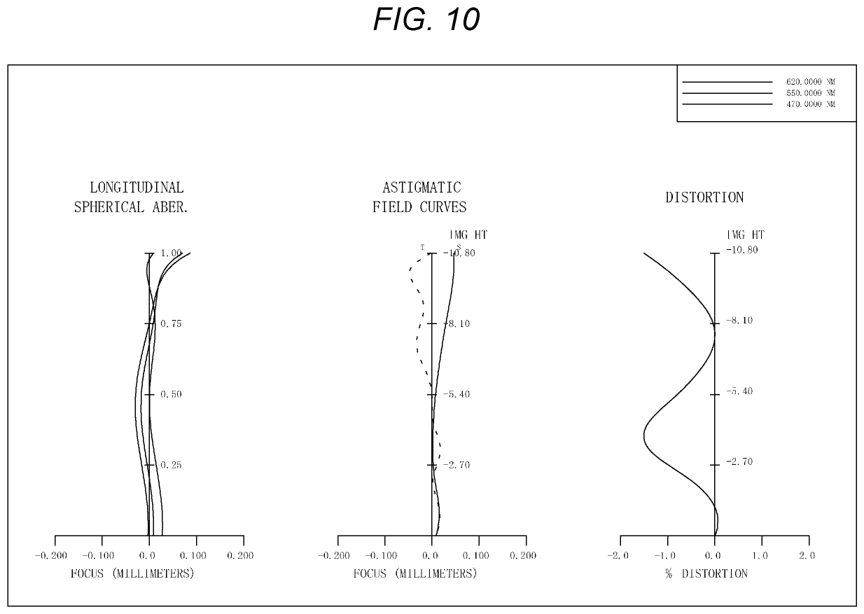

The projection system 3D according to the present example, which satisfies Conditional Expressions (3) to (8), can provide the same effects and advantages as those provided by the projection system 3A according to Example 1. FIG. 10 shows the spherical aberration, astigmatism, and distortion produced by the projection system 3D. The projection system 3D according to the present example allows suppression of the aberrations that degrade an enlarged image, as shown in FIG. 10.

### EXAMPLE 5

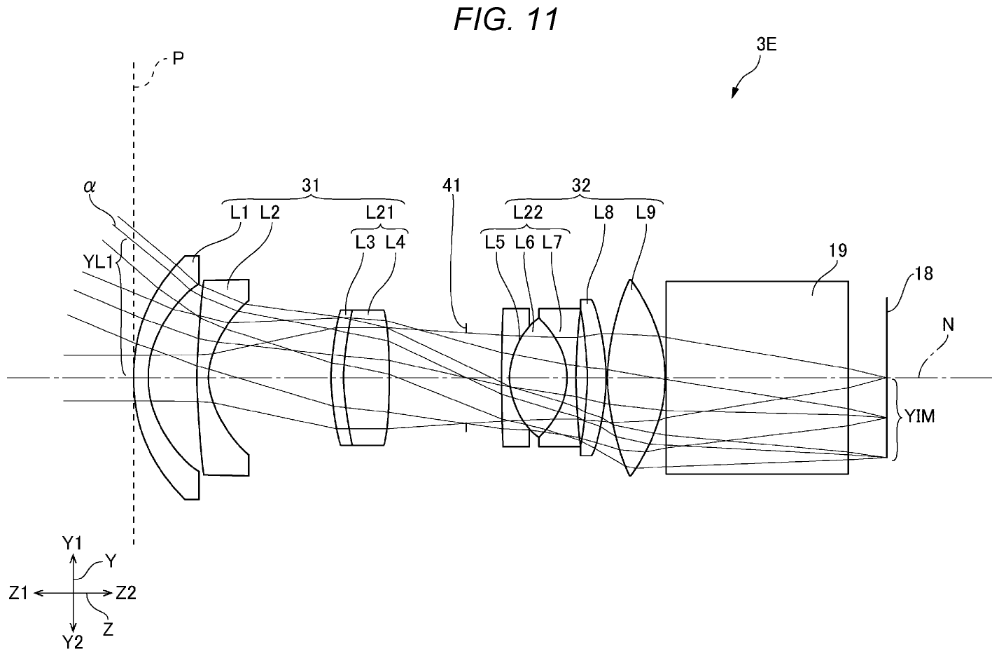

FIG. 11 is a beam diagram showing beams passing through a projection system 3E according to Example 5. The projection system 3E includes a first lens group 31 having positive power, an aperture stop 41, and a second lens group 32 having positive power sequentially arranged from the enlargement side toward the reduction side, as shown in FIG. 11. The aperture stop 41 is set to specify the brightness of the projection system 3E.

The first lens group 31 includes four lenses L1 to L4. The lenses L1 to L4 are arranged in this order from the enlargement side toward the reduction side.

The lens L1 (enlargement-side lens) has negative power. The lens L1 is a meniscus lens. The lens L1 has a convex surface at the enlargement side and a concave surface at the reduction side. The lens L2 has negative power. The lens L2 has a convex surface at the enlargement side and a concave surface at the reduction side. The lens L2 has aspherical surfaces at opposite sides.

The lens L3 (first lens) and the lens L4 (second lens) are bonded to each other into a cemented doublet L21 . The lens L3 has positive power. The lens L3 is a meniscus lens. The lens L3 has a convex surface at the enlargement side and a concave surface at the reduction side. The lens L4 has positive power. The lens L4 has convex surfaces both at the enlargement and reduction sides. The cemented doublet L21 has positive power.

The second lens group 32 includes five lenses L5 to L9. The lenses L5 to L9 are arranged in this order from the enlargement side toward the reduction side.

The lenses L5, L6, and L7 are bonded to each other into a cemented triplet L22. The lens L5 has negative power. The lens L5 is a meniscus lens. The lens L5 has a convex surface at the enlargement side and a concave surface at the reduction side. The lens L6 has positive power. The lens L6 has convex surfaces both at the enlargement and reduction sides. The lens L7 has negative power. The lens L7 has concave surfaces both at the enlargement and reduction sides. The cemented doublet L22 has negative power.

The lens L8 has positive power. The lens L8 is a meniscus lens. The lens L8 has a concave surface at the enlargement side and a convex surface at the reduction side. The lens L9 (reduction-side lens) has positive power. The lens L9 has convex surfaces both at the enlargement and reduction sides. The lens L9 has aspherical surfaces at opposite sides.

The lens L2 is made of resin. The lenses L1 and L3 to L9 are made of glass.

In the projection system 3E, the portion at the reduction side of the lens L9 is a telecentric portion.

Data on the projection system 3E according to Example 5 are listed in a table below. In the table, FNo represents the f number of the projection system 3E, TTL represents the overall optical length, L represents the distance along the optical axis N from the enlargement-side surface of the lens L1 to the reduction-side surface of the lens L9, BF represents the back focal length, ω represents the maximum half angle of view of the overall projection system, F represents the focal length of the overall projection system, Fg1 represents the focal length of the first lens group 31, Fg2 represents the focal length of the second lens group 32, Fls represents the focal length of the lens L1, Flf represents the focal length of the lens L9, and Fc represents the focal length of the cemented doublet L21.

| Fno | 2.022 | |
|---|---|---|
| TTL | 99.125 | mm |
| L | 70.000 | mm |
| Bf | 29.125 | mm |
| ω | 40.216° | |
| F | 12.388 | mm |
| Fg1 | 51.815 | mm |
| Fg2 | 24.823 | mm |
| Fls | −74.517 | mm |
| Flf | 21.011 | mm |
| Fc | 26.445 | mm |

Other data on the projection system 3E according to Example 5 are listed in a table below. In the table, YIM represents the distance from the optical axis N to the largest image height of a projection image formed at the liquid crystal panel 18, and YL1 represents the distance from the optical axis N to a chief beam a corresponding to the largest image height in an imaginary plane P, which passes through the vertex of the enlargement-side lens surface of the lens L1 and is perpendicular to the optical axis N, as shown in FIG. 11.

| | |
|---|---|
| YIM | 10.350 mm |
| YL1 | 18.009 mm |

Data on the lenses of the projection system 3E are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character vd represents the Abbe number at the d line. Reference characters R and D are expressed in millimeters.

| Reference | Surface | | | | |
|---|---|---|---|---|---|
| character | number | R | D | nd | νd |
| S | 0 | inf | 1190.000 | | |
| L01 | 1 | 22.43 | 2.000 | 1.6230 | 58.2 |
| | 2 | 14.62 | 6.415 | | |
| L02 | 3* | −148.69 | 1.500 | 1.5365 | 56.0 |
| | 4* | 12.78 | 16.108 | | |
| L03 | 5 | 31.20 | 1.743 | 1.9037 | 31.3 |
| L04 | 6 | 36.37 | 6.000 | 1.8044 | 39.6 |
| | 7 | −63.07 | 10.097 | | |
| 41 | 8 | inf | 4.689 | | |
| L05 | 9 | 244.61 | 1.000 | 1.5317 | 48.8 |
| L06 | 10 | 10.29 | 7.506 | 1.4970 | 81.5 |
| L07 | 11 | −10.15 | 1.200 | 1.6477 | 33.8 |
| | 12 | 60.66 | 1.403 | | |
| L08 | 13 | −51.24 | 2.526 | 1.7200 | 50.2 |
| | 14 | −29.86 | 0.200 | | |
| L09 | 15* | 24.94 | 7.614 | 1.5365 | 56.0 |
| | 16* | −18.50 | 0.200 | | |
| 19 | 17 | inf | 23.925 | 1.5168 | 64.2 |
| | 18 | inf | 4.950 | | |
| 18 | 19 | inf | 0.05 | | |

The aspherical coefficients are listed below.

| Surface number | 3 | 4 |
|---|---|---|
| Conic constant | 0.00000E+00 | 0.00000E+00 |
| Third-order | 1.93615E−03 | 2.23236E−03 |
| coefficient | | |
| Fourth-order | −2.66907E−05 | −1.57621E−04 |
| coefficient | | |
| Fifth-order | −1.19541E−05 | 6.77330E−06 |
| coefficient | | |
| Sixth-order | 1.15454E−07 | −8.91725E−07 |
| coefficient | | |
| Seventh-order | 5.55324E−08 | −8.57616E−08 |
| coefficient | | |
| Eighth-order | 1.12225E−09 | 3.32983E−09 |
| coefficient | | |
| Ninth-order | −3.92719E−10 | 1.19811E−09 |
| coefficient | | |
| Tenth-order | 1.28061E−11 | −8.30314E−11 |
| coefficient | | |
| Surface number | 15 | 16 |
| Conic constant | 0.00000E+00 | 0.00000E+00 |
| Fourth-order | −3.14658E−05 | 2.32078E−05 |
| coefficient | | |
| Sixth-order | 6.07696E−08 | 2.35492E−08 |
| coefficient | | |
| Eighth-order | −3.38344E−10 | −2.15202E−10 |
| coefficient | | |
| Tenth-order | 8.97097E−13 | 1.19144E−12 |
| coefficient | | |

The projection system 3E according to the present example satisfies Conditional Expressions (1) and (2) below,

ω>40° (1)

YL1/YIM<6.0 (2)

where ω represents the maximum half angle of view of the overall projection system, YIM represents the distance from the optical axis N to the largest image height of the projection image formed at the liquid crystal panel 18, and YL1 represents the distance from the optical axis N to a chief beam a corresponding to the largest image height in an imaginary plane P, which passes through the vertex of the enlargement-side lens surface of the lens L1 and is perpendicular to the optical axis N.

In the present example,

| | |
|---|---|
| ω | 40.216° |
| YIM | 10.350 mm |
| YL1 | 18.009 mm |

are satisfied. Therefore, ω=40.216° is provided, so that Conditional Expression (1) is satisfied. YL1/YIM=1.740 is achieved, so that Conditional Expression (2) is satisfied.

The projection system 3E according to the present example satisfies all Conditional Expressions (3), (4), and (5) below,

BF/F>2.0 (3)

−15.0<Fls/F<−1.8 (4)

1.6<Flf/F<15.0 (5)

where F represents the focal length of the overall projection system, BF represents the back focal length in air, Fls represents the focal length of the lens L1, and Flf represents the focal length of the lens L9.

In the present example,

| | |
|---|---|
| Bf | 29.125 mm |
| F | 12.388 mm |
| Fls | −74.517 mm |
| Flf | 21.011 mm |

are satisfied. BF/F=2.351 is therefore achieved, so that Conditional Expression (3) is satisfied. Fls/F=−6.015 is achieved, so that Conditional Expression (4) is satisfied. Flf/F=1.696 is achieved, so that Conditional Expression (5) is satisfied.

The projection system 3E according to the present example satisfies all Conditional Expressions (6), (7), and (8) below,

|Δνd|<20.0 (6)

|Δnd|<0.35 (7)

2.0<Fc/F<15.0 (8)

where F represents the focal length of the overall projection system, Δνd represents the difference in Abbe number at the d line between the lenses L3 and L4, Δnd represents the difference in refractive index at the d line between the lenses L3 and L4, and Fc represents the focal length of the cemented doublet L21.

In the present example,

| F | 12.388 mm |
|---|---|
| Fc | 26.445 mm |
| \|Δνd\| | 8.243 |
| \|Δnd\| | 0.099 |

are satisfied. Therefore, |Δνd|=8.243 is provided, so that Conditional Expression (6) is satisfied. |Δνd|=0.099 is provided, so that Conditional Expression (7) is satisfied. Fc/F=2.135 is achieved, so that Conditional Expression (8) is satisfied.

### Effects and Advantages

The projection system 3E according to the present example, which satisfies Conditional Expression (1), is a wide-angle projection system. In the projection system 3E according to the present example, in which the first lens group 31 has positive power and which satisfies Conditional Expression (2), the lens that forms the first lens group and is disposed at a position closest to the enlargement side can be smaller than the largest image height of the projection image formed at the liquid crystal panel 18.

In the projection system 3E according to the present example, the lens L1 has negative power. The maximum half angle of view of the projection system 3E is therefore readily increased. In the present example, the lens L9 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1 and L2 are each a negative lens having negative power. The lens L2 is an aspherical lens made of plastic. According to the configuration described above, image curvature produced by the projection system 3E can be suppressed.

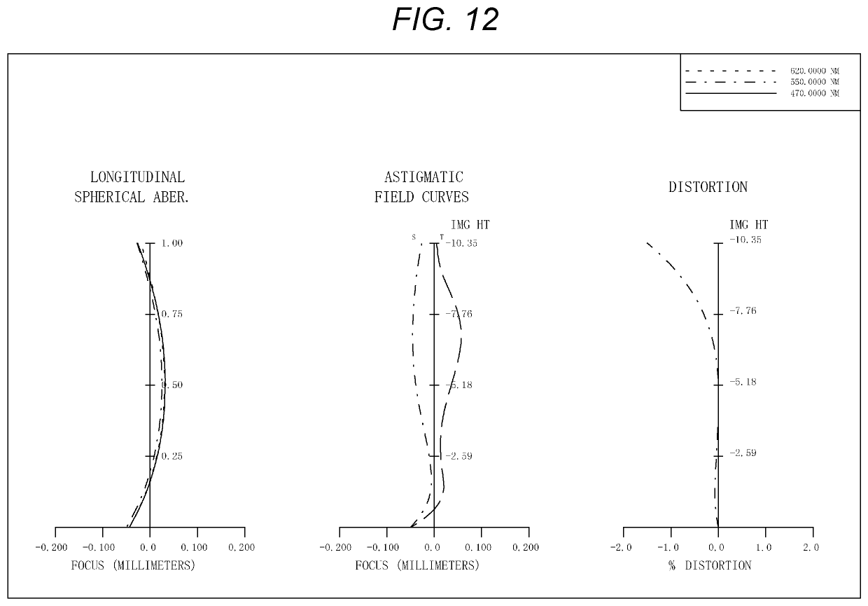

The projection system 3E according to the present example, which satisfies Conditional Expressions (3) to (8), can provide the same effects and advantages as those provided by the projection system 3A according to Example 1. FIG. 12 shows the spherical aberration, astigmatism, and distortion produced by the projection system 3E. The projection system 3E according to the present example allows suppression of the aberrations that degrade an enlarged image, as shown in FIG. 12.

### EXAMPLE 6

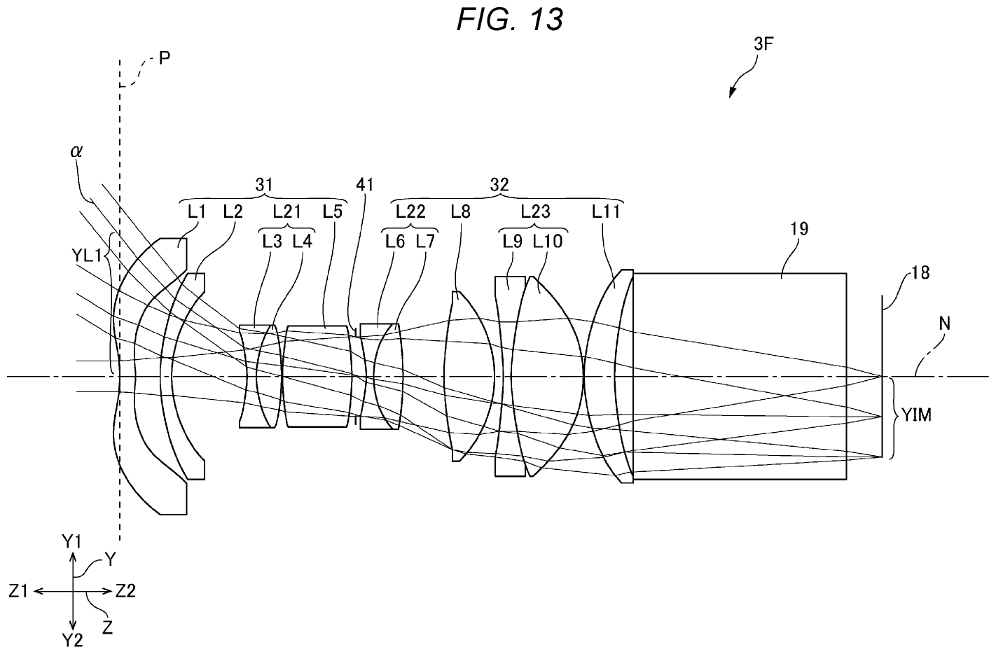

FIG. 13 is a beam diagram showing beams passing through a projection system 3F according to Example 6. The projection system 3F includes a first lens group 31 having positive power, an aperture stop 41, and a second lens group 32 having positive power sequentially arranged from the enlargement side toward the reduction side, as shown in FIG. 13. The aperture stop 41 is set to specify the brightness of the projection system 3F.

The first lens group 31 includes five lenses L1 to L5. The lenses L1 to L5 are arranged in this order from the enlargement side toward the reduction side.

The lens L1 (enlargement-side lens) has negative power. The enlargement-side surface of the lens L1 has a concave shape in the vicinity of the optical axis N and a convex shape at the periphery. The reduction-side surface of the lens

L1 has a convex shape in the vicinity of the optical axis N and a concave shape at the periphery. The lens L1 has aspherical surfaces at opposite sides. The lens L2 has negative power. The lens L2 is a meniscus lens. The lens L2 has a convex surface at the enlargement side and a concave surface at the reduction side.

The lens L3 (first lens) and the lens L4 (second lens) are bonded to each other into a cemented doublet L21. The lens L3 has negative power. The lens L3 has concave surfaces both at the enlargement and reduction sides. The lens L4 has positive power. The lens L4 has convex surfaces both at the enlargement and reduction sides. The cemented doublet L21 has negative power.

The lens L5 has positive power. The lens L5 has convex surfaces both at the enlargement and reduction sides.

The second lens group 32 includes six lenses L6 to L11. The lenses L6 to L11 are arranged in this order from the enlargement side toward the reduction side.

The lenses L6 and L7 are bonded to each other into a cemented doublet L22. The lens L6 has negative power. The lens L6 has concave surfaces both at the enlargement and reduction sides. The lens L7 has positive power. The lens L7 has convex surfaces both at the enlargement and reduction sides. The cemented doublet L22 has negative power.

The lens L8 has positive power. The lens L8 has convex surfaces both at the enlargement and reduction sides. The lens L8 has aspherical surfaces at opposite sides.

The lens L9 and the lens L10 are bonded to each other into a cemented doublet L23. The lens L9 has negative power. The lens L9 has concave surfaces both at the enlargement and reduction sides. The lens L10 has positive power. The lens L10 has convex surfaces both at the enlargement and reduction sides. The lens L10 has an aspherical surface at the reduction side. The cemented doublet L23 has positive power.

The lens L11 (reduction-side lens) has positive power. The lens L11 is a meniscus lens. The lens L11 has a concave surface at the enlargement side and a convex surface at the reduction side.

The lens L1 is made of resin. The lenses L2 to L11 are made of glass.

In the projection system 3F, the portion at the reduction side of the lens L11 is a telecentric portion.

Data on the projection system 3F according to Example 6 are listed in a table below. In the table, FNo represents the f number of the projection system 3F, TTL represents the overall optical length, L represents the distance along the optical axis N from the enlargement-side surface of the lens L1 to the reduction-side surface of the lens L11, BF represents the back focal length, ω represents the maximum half angle of view of the overall projection system, F represents the focal length of the overall projection system, Fg1 represents the focal length of the first lens group 31, Fg2 represents the focal length of the second lens group 32, Fls represents the focal length of the lens L1, Flf represents the focal length of the lens L11, and Fc represents the focal length of the cemented doublet L21.

| Fno | 2.000 | |
|---|---|---|
| TTL | 98.341 | mm |
| L | 63.842 | mm |
| Bf | 34.499 | mm |
| ω | 51.245° | |
| F | 8.362 | mm |
| Fg1 | 80.458 | mm |
| Fg2 | 19.941 | mm |
| Fls | −36.522 | mm |
| Flf | 100.001 | mm |
| Fc | −23.752 | mm |

Other data on the projection system 3F according to Example 6 are listed in a table below. In the table, YIM represents the distance from the optical axis N to the largest image height of a projection image formed at the liquid crystal panel 18, and YL1 represents the distance from the optical axis N to a chief beam a corresponding to the largest image height in an imaginary plane P, which passes through the vertex of the enlargement-side lens surface of the lens L1 and is perpendicular to the optical axis N, as shown in FIG. 13.

| | |
|---|---|
| YIM | 10.350 mm |
| YL1 | 18.189 mm |

Data on the lenses of the projection system 3F are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character vd represents the Abbe number at the d line. Reference characters R and D are expressed in millimeters.

| Reference | Surface | | | | |
|---|---|---|---|---|---|
| character | number | R | D | nd | νd |
| S | 0 | inf | 730.000 | | |
| L01 | 1* | −8.71 | 2.000 | 1.5311 | 55.8 |
| | 2* | −17.02 | 3.172 | | |
| L02 | 3 | 26.37 | 1.398 | 1.9229 | 20.9 |
| | 4 | 15.68 | 10.115 | | |
| L03 | 5 | −19.67 | 1.200 | 1.8919 | 37.1 |
| L04 | 6 | 12.15 | 3.202 | 1.6398 | 34.5 |
| | 7 | −30.25 | 0.100 | | |
| L05 | 8 | 28.62 | 8.995 | 1.9229 | 20.9 |
| | 9 | −32.73 | 0.321 | | |
| 41 | 10 | inf | 1.192 | | |
| L06 | 11 | −20.65 | 1.000 | 1.9537 | 32.3 |
| L07 | 12 | 10.45 | 3.797 | 1.7847 | 25.7 |
| | 13 | −41.30 | 5.285 | | |
| L08 | 14* | 37.90 | 6.502 | 1.4971 | 81.6 |
| | 15* | −13.52 | 1.281 | | |
| L09 | 16 | −50.19 | 1.000 | 2.0006 | 25.5 |
| L10 | 17 | 34.48 | 9.279 | 1.4971 | 81.6 |
| | 18* | −14.80 | 0.100 | | |
| L11 | 19 | 21.54 | 3.90 | 1.4970 | 81.55 |
| | 20 | 35.66 | 2.50 | | |
| 19 | 21 | inf | 27.43 | 1.5168 | 64.20 |
| | 22 | inf | 4.55 | | |
| 18 | 23 | inf | 0.02 | | |

The aspherical coefficients are listed below.

| Surface number | 1 | 2 |
|---|---|---|
| Conic constant | −3.42002E+00 | −5.60704E−01 |
| Third-order | 4.25232E−03 | 4.31180E−03 |
| coefficient | | |
| Fourth-order | 3.01571E−04 | 3.92102E−04 |
| coefficient | | |
| Fifth-order | −7.90368E−05 | −3.48447E−06 |
| coefficient | | |
| Sixth-order | 4.97710E−06 | −4.42544E−06 |
| coefficient | | |
| Seventh-order | −7.29863E−08 | 2.29437E−08 |
| coefficient | | |
| Eighth-order | −3.95536E−09 | 2.41870E−08 |
| coefficient | | |
| Ninth-order | 1.38060E−10 | −1.13025E−10 |
| coefficient | | |
| Tenth-order | −4.19421E−13 | −4.95628E−11 |
| coefficient | | |

| Surface number | 14 | 15 | 18 |
|---|---|---|---|
| Conic constant | 3.45419E+00 | −8.53411E−03 | −1.69646E+00 |
| Fourth-order | −3.32603E−05 | 6.87379E−05 | −5.39809E−05 |
| coefficient | | | |
| Sixth-order | 1.87962E−07 | 1.32192E−07 | 0.00000E+00 |
| coefficient | | | |
| Eighth-order | −3.04817E−09 | −1.55278E−09 | 0.00000E+00 |
| coefficient | | | |
| Tenth-order | 1.78417E−11 | 7.00890E−12 | 0.00000E+00 |
| coefficient | | | |
| Twelfth-order | −4.67443E−14 | 0.00000E+00 | 0.00000E+00 |
| coefficient | | | |

The projection system 3F according to the present example satisfies Conditional Expressions (1) and (2) below,

ω>40° (1)

YL1/YIM<6.0 (2)

where ω represents the maximum half angle of view of the overall projection system, YIM represents the distance from the optical axis N to the largest image height of the projection image formed at the liquid crystal panel 18, and YL1 represents the distance from the optical axis N to a chief beam a corresponding to the largest image height in an imaginary plane P, which passes through the vertex of the enlargement-side lens surface of the lens L1 and is perpendicular to the optical axis N.

In the present example,

| | |
|---|---|
| ω | 51.245° |
| YIM | 10.350 mm |
| YL1 | 18.189 mm |

are satisfied. Therefore, ω=51.245° is provided, so that Conditional Expression (1) is satisfied. YL1/YIM=1.757 is achieved, so that Conditional Expression (2) is satisfied.

The projection system 3F according to the present example satisfies all Conditional Expressions (3), (4), and (5) below,

BF/F>2.0 (3)

−15.0<Fls/F<−1.8 (4)

1.6<Flf/F<15.0 (5)

where F represents the focal length of the overall projection system, BF represents the back focal length in air, Fls represents the focal length of the lens L1, and Flf represents the focal length of the lens L11.

In the present example,

| | |
|---|---|
| Bf | 34.499 mm |
| F | 8.362 mm |
| Fls | −36.522 mm |
| Flf | 100.001 mm |

are satisfied. BF/F=4.126 is therefore achieved, so that Conditional Expression (3) is satisfied. Fls/F=−4.368 is achieved, so that Conditional Expression (4) is satisfied. Flf/F=11.960 is achieved, so that Conditional Expression (5) is satisfied.

The projection system 3F according to the present example satisfies all Conditional Expressions (6), (7), and (8) below,

|Δνd|<20.0 (6)

|Δnd|<0.35 (7)

2.0<Fc/F<15.0 (8)

where F represents the focal length of the overall projection system, Δνd represents the difference in Abbe number at the d line between the lenses L3 and L4, Δnd represents the difference in refractive index at the d line between the lenses L3 and L4, and Fc represents the focal length of the cemented doublet L21.

In the present example,

| F | 8.362 mm |
|---|---|
| Fc | −23.752 mm |
| \|Δνd\| | 2.668 |
| \|Δnd\| | 0.254 |

are satisfied. Therefore, |Δνd|=2.668 is provided, so that Conditional Expression (6) is satisfied. |Δνd|=0.254 is provided, so that Conditional Expression (7) is satisfied. Fc/F=2.841 is achieved, so that Conditional Expression (8) is satisfied.

### Effects and Advantages

The projection system 3F according to the present example, which satisfies Conditional Expression (1), is a wide-angle projection system. In the projection system 3F according to the present example, in which the first lens group 31 has positive power and which satisfies Conditional Expression (2), the lens that forms the first lens group and is disposed at a position closest to the enlargement side can be smaller than the largest image height of the projection image formed at the liquid crystal panel 18.

In the projection system 3F according to the present example, the lens L1 has negative power. The maximum half angle of view of the projection system 3F is therefore readily increased. In the present example, the lens L11 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1 and L2 are each a negative lens having negative power. The lens L1 is an aspherical lens made of plastic. According to the configuration described above, image curvature produced by the projection system 3F can be suppressed.

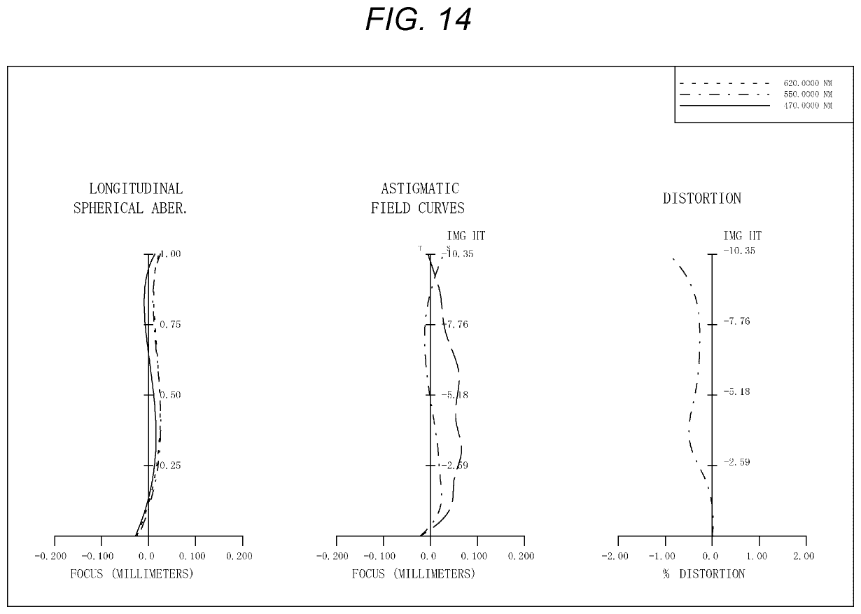

The projection system 3F according to the present example, which satisfies Conditional Expressions (3) to (8), can provide the same effects and advantages as those provided by the projection system 3A according to Example 1. FIG. 14 shows the spherical aberration, astigmatism, and distortion produced by the projection system 3F. The projection system 3F according to the present example allows suppression of the aberrations that degrade an enlarged image, as shown in FIG. 14.

### EXAMPLE 7

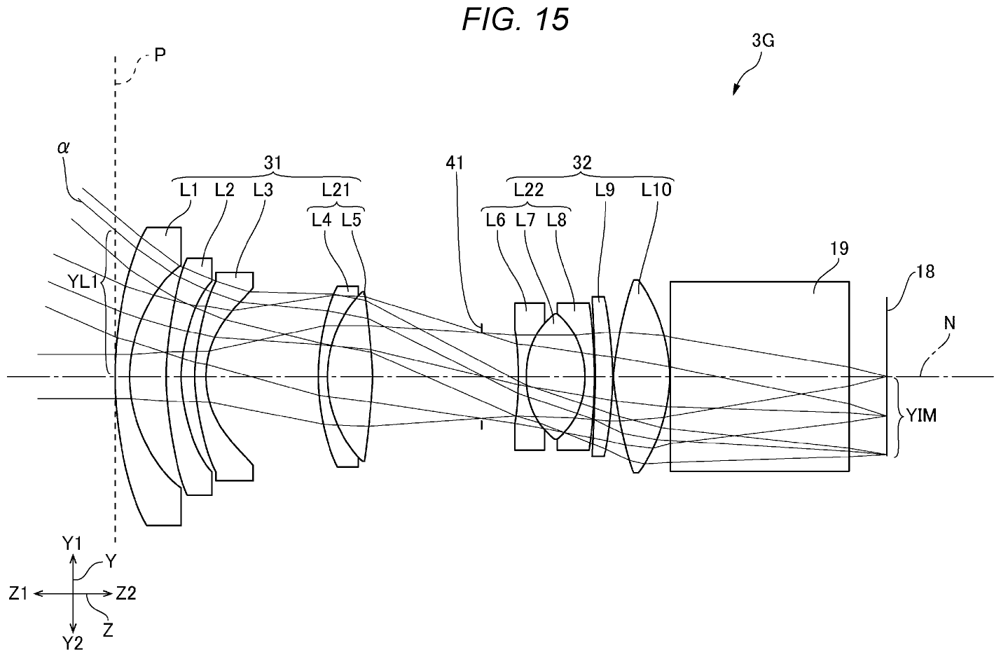

FIG. 15 is a beam diagram showing beams passing through a projection system 3G according to Example 7. The projection system 3G includes a first lens group 31 having positive power, an aperture stop 41, and a second lens group 32 having positive power sequentially arranged from the enlargement side toward the reduction side, as shown in FIG. 15. The aperture stop 41 is set to specify the brightness of the projection system 3G.

The first lens group 31 includes five lenses L1 to L5. The lenses L1 to L5 are arranged in this order from the enlargement side toward the reduction side.

The lens L1 (enlargement-side lens) has negative power. The lens L1 is a meniscus lens. The lens L1 has a convex surface at the enlargement side and a concave surface at the reduction side. The lens L2 has negative power. The lens L2 is a meniscus lens. The lens L2 has a convex surface at the enlargement side and a concave surface at the reduction side.

The lens L3 is a meniscus lens. The lens L3 has a convex surface at the enlargement side and a concave surface at the reduction side. The lens L3 has aspherical surfaces at opposite sides.

The lens L4 (first lens) and the lens L5 (second lens) are bonded to each other into a cemented doublet L21. The lens L4 has negative power. The lens L4 is a meniscus lens. The lens L4 has a convex surface at the enlargement side and a concave surface at the reduction side. The lens L5 has positive power. The lens L5 has convex surfaces both at the enlargement and reduction sides. The cemented doublet L21 has positive power.

The second lens group 32 includes five lenses L6 to L10. The lenses L5 to L10 are arranged in this order from the enlargement side toward the reduction side.

The lenses L6, L7, and L8 are bonded to each other into a cemented triplet L22. The lens L6 has negative power. The lens L6 has concave surfaces both at the enlargement and reduction sides. The lens L7 has positive power. The lens L7 has convex surfaces both at the enlargement and reduction sides. The lens L8 has negative power. The lens L8 is a meniscus lens. The lens L8 has a convex surface at the enlargement side and a concave surface at the reduction side. The cemented doublet L22 has negative power.

The lens L9 has positive power. The lens L9 is a meniscus lens. The lens L9 has a concave surface at the enlargement side and a convex surface at the reduction side. The lens L10 (reduction-side lens) has positive power. The lens L10 has convex surfaces both at the enlargement and reduction sides. The lens L10 has aspherical surfaces at opposite sides.

The lens L3 is made of resin. The lenses L1, L2, L4 to L10 are made of glass.

In the projection system 3G, the portion at the reduction side of the lens L10 is a telecentric portion.

Data on the projection system 3G according to Example 7 are listed in a table below. In the table, FNo represents the f number of the projection system 3G, TTL represents the overall optical length, L represents the distance along the optical axis N from the enlargement-side surface of the lens L1 to the reduction-side surface of the lens L10, BF represents the back focal length, ω represents the maximum half angle of view of the overall projection system, F represents the focal length of the overall projection system, Fg1 represents the focal length of the first lens group 31, Fg2 represents the focal length of the second lens group 32, Fls represents the focal length of the lens L1, Flf represents the focal length of the lens L10, and Fc represents the focal length of the cemented doublet L21.

| Fno | 2.022 | |
|---|---|---|
| TTL | 104.024 | mm |
| L | 75.000 | mm |
| Bf | 29.024 | mm |
| ω | 40.801° | |
| F | 12.134 | mm |
| Fg1 | 50.531 | mm |
| Fg2 | 23.981 | mm |
| Fls | −67.029 | mm |
| Flf | 21.642 | mm |
| Fc | 26.162 | mm |

Other data on the projection system 3G according to Example 7 are listed in a table below. In the table, YIM represents the distance from the optical axis N to the largest image height of a projection image formed at the liquid crystal panel 18, and YL1 represents the distance from the optical axis N to a chief beam a corresponding to the largest image height in an imaginary plane P, which passes through the vertex of the enlargement-side lens surface of the lens L1 and is perpendicular to the optical axis N, as shown in FIG. 15.

| | |
|---|---|
| YIM | 10.350 mm |
| YL1 | 19.527 mm |

Data on the lenses of the projection system 3G are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character vd represents the Abbe number at the d line. Reference characters R and D are expressed in millimeters.

| Reference | Surface | | | | |
|---|---|---|---|---|---|
| character | number | R | D | nd | νd |
| S | 0 | inf | 1190.000 | | |
| L01 | 1 | 48.30 | 2.000 | 1.4875 | 70.2 |
| | 2 | 19.26 | 5.054 | | |
| L02 | 3 | 46.84 | 2.000 | 1.5378 | 74.7 |
| | 4 | 21.45 | 1.846 | | |
| L03 | 5* | 73.21 | 1.500 | 1.5365 | 56.0 |
| | 6* | 14.06 | 15.132 | | |
| L04 | 7 | 29.24 | 1.200 | 1.9037 | 31.3 |
| L05 | 8 | 15.81 | 6.000 | 1.8044 | 39.6 |
| | 9 | −54.29 | 14.872 | | |
| 41 | 10 | inf | 4.993 | | |
| L06 | 11 | −48.08 | 1.000 | 1.5317 | 48.8 |
| L07 | 12 | 10.76 | 8.000 | 1.4970 | 81.5 |
| L08 | 13 | −11.07 | 1.200 | 1.6477 | 33.8 |
| | 14 | −83.40 | 0.200 | | |
| L09 | 15 | −85.46 | 2.282 | 1.7200 | 50.2 |
| | 16 | −49.52 | 0.200 | | |
| L10 | 17* | 26.21 | 7.521 | 1.5365 | 56.0 |
| | 18* | −18.88 | 0.200 | | |
| 19 | 19 | inf | 23.93 | 1.5168 | 64.2 |
| | 20 | inf | 4.85 | | |
| 19 | 21 | inf | 0.05 | | |

The aspherical coefficients are listed below.

| Surface number | 5 | 6 |
|---|---|---|
| Conic constant | 0.00000E+00 | 0.00000E+00 |
| Third-order | 1.57900E−03 | 1.85263E−03 |
| coefficient | | |
| Fourth-order | 6.96953E−05 | −4.47240E−05 |
| coefficient | | |
| Fifth-order | −1.36372E−05 | 1.04252E−06 |
| coefficient | | |
| Sixth-order | −3.02221E−07 | −8.19992E−07 |
| coefficient | | |
| Seventh-order | 4.84025E−08 | −7.76252E−08 |
| coefficient | | |
| Eighth-order | 2.52624E−09 | 1.95332E−09 |
| coefficient | | |
| Ninth-order | −2.99137E−10 | 1.09687E−09 |
| coefficient | | |
| Tenth-order | 6.56267E−12 | −6.17508E−11 |
| coefficient | | |
| Surface number | 17 | 18 |
| Conic constant | 0.00000E+00 | 0.00000E+00 |
| Fourth-order | −2.94834E−05 | 3.01111E−05 |
| coefficient | | |
| Sixth-order | 7.70708E−08 | 3.90288E−08 |
| coefficient | | |
| Eighth-order | −5.67005E−10 | −4.82412E−10 |
| coefficient | | |
| Tenth-order | 1.54988E−12 | 1.60978E−12 |
| coefficient | | |

The projection system 3G according to the present example satisfies Conditional Expressions (1) and (2) below,

ω>40° (1)

YL1/YIM<6.0 (2)

where ω represents the maximum half angle of view of the overall projection system, YIM represents the distance from the optical axis N to the largest image height of the projection image formed at the liquid crystal panel 18, and YL1 represents the distance from the optical axis N to a chief beam a corresponding to the largest image height in an imaginary plane P, which passes through the vertex of the enlargement-side lens surface of the lens L1 and is perpendicular to the optical axis N.

In the present example,

| | |
|---|---|
| ω | 40.801° |
| YIM | 10.350 mm |
| YL1 | 19.527 mm |

are satisfied. Therefore, ω=40.801° is provided, so that Conditional Expression (1) is satisfied. YL1/YIM=1.887 is achieved, so that Conditional Expression (2) is satisfied.

The projection system 3G according to the present example satisfies all Conditional Expressions (3), (4), and (5) below,

BF/F>2.0 (3)

−15.0<Fls/F<−1.8 (4)

1.6<Flf/F<15.0 (5)

where F represents the focal length of the overall projection system, BF represents the back focal length in air, Fls represents the focal length of the lens L1, and Flf represents the focal length of the lens L10.

In the present example,

| | |
|---|---|
| Bf | 29.024 mm |
| F | 12.134 mm |
| Fls | −67.029 mm |
| Flf | 21.642 mm |

are satisfied. BF/F=2.392 is therefore achieved, and Conditional Expression (3) is satisfied. Fls/F=−5.524 is achieved, so that Conditional Expression (4) is satisfied. Flf/F=1.784 is achieved, so that Conditional Expression (5) is satisfied.

The projection system 3G according to the present example satisfies all Conditional Expressions (6), (7), and (8) below,

|Δνd|<20.0 (6)

|Δnd|<0.35 (7)

2.0<Fc/F<15.0 (8)

where F represents the focal length of the overall projection system, Δνd represents the difference in Abbe number at the d line between the lenses L4 and L5, Δnd represents the difference in refractive index at the d line between the lenses L4 and L5, and Fc represents the focal length of the cemented doublet L21.

In the present example,

| F | 12.134 mm |
|---|---|
| Fc | 26.162 mm |
| \|Δνd\| | 2.668 |
| \|Δnd\| | 0.254 |

are satisfied. Therefore, |Δνd|=2.668 is provided, so that Conditional Expression (6) is satisfied. |Δνd|=0.254 is provided, so that Conditional Expression (7) is satisfied. Fc/F=2.156 is achieved, so that Conditional Expression (8) is satisfied.

### Effects and Advantages

The projection system 3G according to the present example, which satisfies Conditional Expression (1), is a wide-angle projection system. In the projection system 3G according to the present example, in which the first lens group 31 has positive power and which satisfies Conditional Expression (2), the lens that forms the first lens group and is disposed at a position closest to the enlargement side can be smaller than the largest image height of the proj ection image formed at the liquid crystal panel 18.

In the projection system 3G according to the present example, the lens L1 has negative power. The maximum half angle of view of the projection system 3G is therefore readily increased. In the present example, the lens L10 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1, L2, and L3 are each a negative lens having negative power. The lens L3 is an aspherical lens made of plastic. According to the configuration described above, image curvature produced by the projection system 3G can be suppressed.

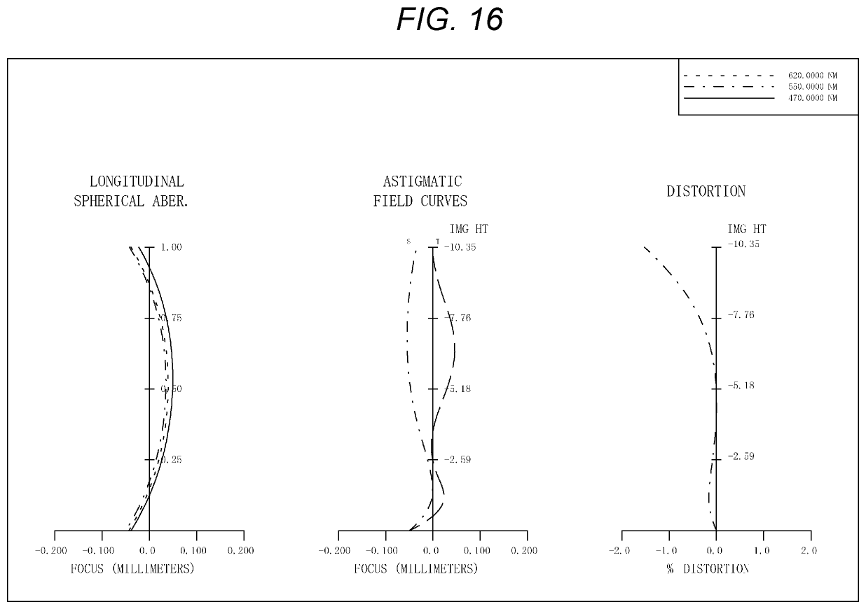

The projection system 3G according to the present example, which satisfies Conditional Expressions (3) to (8), can provide the same effects and advantages as those provided by the projection system 3A according to Example 1. FIG. 16 shows the spherical aberration, astigmatism, and distortion produced by the projection system 3G. The projection system 3G according to the present example allows suppression of the aberrations that degrade an enlarged image, as shown in FIG. 16.

### OTHER EXAMPLES

In the examples described above, focusing can be performed by moving one or more of the lenses in the first lens group 31 along the optical axis N. In this case, it is desirable to move a cemented doublet or triplet or a positive lens contained in the first lens group 31 along the optical axis N.

A preferable embodiment of the present disclosure has been described above. The present disclosure is, however, not limited to the specific embodiment described above, and a variety of modifications and changes can be made to the embodiment within the intent of the present disclosure described in the claims as long as no particular limitation is set in the above description. As an example, in the embodiment of the present disclosure, the liquid crystal panel 18 is used as the image formation devices, but the liquid crystal panel 18 is not necessarily used and may be replaced, for example, with reflective liquid crystal panels or digital micromirror devices (DMDs).

What is claimed is:

1. A projection system for enlarging a projection image formed by an image formation device disposed in a reduction-side conjugate plane and projecting the enlarged image onto an enlargement-side conjugate plane, the projection system comprising:
a first lens group having positive power, and an aperture stop, and a second lens group having positive power sequentially arranged from an enlargement side toward a reduction side,
a portion at the reduction side of a reduction-side lens that forms the second lens group and is located at a position closest to the reduction side is a telecentric portion, and
the projection system satisfies Conditional Expressions (1) and (2) below,
ω>40° (1)
YL1/YIM<6.0 (2)
where ω represents a maximum half angle of view of the overall projection system, YIM represents a distance from an optical axis to a largest image height of the projection image formed at the image formation device, and YL1 is a distance from the optical axis to a chief beam corresponding to the maximum image height in an imaginary plane that is perpendicular to the optical axis and passes through a vertex of an enlargement-side lens surface of an enlargement-side lens that forms the first lens group and is located at a position closest to the enlargement side.

2. The projection system according to claim 1,
wherein the enlargement-side lens has negative power, and
the reduction-side lens has positive power.

3. The projection system according to claim 1,
wherein the first lens group includes a plurality of negative lenses arranged in succession from a position closest to the enlargement side toward the reduction side, and
one of the plurality of negative lenses is an aspherical lens made of plastic.

4. The projection system according to claim 1, wherein the projection system satisfies all Conditional Expressions (3), (4), and (5) below,
BF/F>2.0 (3)
−15.0<Fls/F<−1.8 (4)
1.6<Flf/F<15.0 (5)
where F represents a focal length of the overall projection system, BF represents aback focal length in air, Fls represents a focal length of the enlargement-side lens, and Flf represents a focal length of the reduction-side lens.

5. The projection system according to claim 1,
wherein the first lens group includes a cemented doublet into which a first lens and a second lens are bonded to each other, and
the projection system satisfies all Conditional Expressions (6), (7, and (8) below,

|Δνd|<20.0 (6)

|Δnd|<0.35 (7)
2.0<Fc/F<15.0 (8)
where F represents a focal length of the overall projection system, Δνd represents a difference in an Abbe number at a d line between the first lens and the second lens, Δnd represents a difference in a refractive index at the d line between the first lens and the second lens, and Fc represents a focal length of the cemented doublet.

6. A projector comprising:
the projection system according to claim 1; and
the image formation device that forms a projection image in the reduction-side conjugate plane of the projection system.
